(19) United States
(12) Patent Application Publication
(10) Pub. No.: US 2026/0261889 A1
(43) Pub. Date: Sep. 3, 2026

(54) DIGITAL-TWIN-ASSISTED CHANNEL CHARACTERIZATION

(71) Applicant: QUALCOMM Incorporated, San Diego, CA (US)

(72) Inventors: Andrei Dragos RADULESCU, La Jolla, CA (US); Vinay CHANDE, San Diego, CA (US); Rajat PRAKASH, San Diego, CA (US); Xiaoxia ZHANG, San Diego, CA (US); Mostafa KHOSHNEVISAN, San Diego, CA (US); Mohammed Ali Mohammed HIRZALLAH, Winchester, CA (US)

(21) Appl. No.: 19/551,009

(22) Filed: Feb. 26, 2026

Related U.S. Application Data
(60) Provisional application No. 63/765,215, filed on Feb. 28, 2025.

(51) Int. Cl. H04W 24/08

(52) U.S. Cl. CPC H04W 24/08

(57) ABSTRACT

Various aspects of the present disclosure generally relate to wireless communication. In some aspects, a first network node may transmit, to a second network node associated with a digital-twin service, a message including a request for channel characterization data associated with a user equipment (UE). The first network node may receive, from the second network node, a message including the channel characterization data associated with the UE, wherein the channel characterization data includes measurement information associated with a set of measurements associated with the UE. Numerous other aspects are described.

### CROSS-REFERENCE TO RELATED APPLICATION

This Patent Application claims priority to U.S. Provisional Patent Application No. 63/765,215, filed on February 28, 2025, entitled “DIGITAL-TWIN-ASSISTED CHANNEL CHARACTERIZATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with digital-twin-assisted channel characterization.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Channel estimation and channel state knowledge enable efficient and reliable data transmission in a wireless network. Channel estimation includes determining the characteristics of a wireless channel, including scattering, fading, and power attenuation, which may affect signal propagation from a transmitter to a receiver. This information may be included in channel state information (CSI) that is reported to components of the wireless network. The wireless network may utilize the CSI to adapt transmission strategies to current channel conditions, thereby mitigating interference and improving communication efficiency and effectiveness.

### SUMMARY

The systems, methods, and devices of this disclosure each have several innovative aspects, no single one of which is solely responsible for the desirable attributes disclosed herein.

Some aspects described herein relate to a first network node. The first network node may include a processing system. The processing system may include one or more processors and one or more code-storing memories coupled with the one or more processors. The processing system may be configured to cause the first network node to transmit, to a second network node associated with a digital-twin (DT) service, a message including a request for channel characterization data associated with a user equipment (UE). The processing system may be configured to cause the first network node to receive, from the second network node, a message including the channel characterization data associated with the UE, wherein the channel characterization data includes measurement information associated with a set of measurements associated with the UE.

Some aspects described herein relate to a second network node. The second network node may include a processing system. The processing system may include one or more processors and one or more code-storing memories coupled with the one or more processors. The processing system may be configured to cause the second network node to receive, from a first network node, a message including a request for channel characterization data associated with a UE. The processing system may be configured to cause the second network node to transmit, to the first network node, a message including the channel characterization data associated with the UE, wherein the channel characterization data includes measurement information associated with a set of measurements associated with the UE.

Some aspects described herein relate to a method of wireless communication performed by a first network node. The method may include transmitting, to a second network node associated with a DT service, a message including a request for channel characterization data associated with a UE. The method may include receiving, from the second network node, a message including the channel characterization data associated with the UE, wherein the channel characterization data includes measurement information associated with a set of measurements associated with the UE.

Some aspects described herein relate to a method of wireless communication performed by a second network node associated with a DT service. The method may include receiving, from a first network node, a message including a request for channel characterization data associated with a UE. The method may include transmitting, to the first network node, a message including the channel characterization data associated with the UE, wherein the channel characterization data includes measurement information associated with a set of measurements associated with the UE.

Some aspects described herein relate to a non-transitory computer-readable medium that stores a set of instructions for wireless communication by a first network node. The set of instructions, when executed by one or more processors of the first network node, may cause the first network node to transmit, to a second network node associated with a DT service, a message including a request for channel characterization data associated with a UE. The set of instructions, when executed by one or more processors of the first network node, may cause the first network node to receive, from the second network node, a message including the channel characterization data associated with the UE, wherein the channel characterization data includes measurement information associated with a set of measurements associated with the UE.

Some aspects described herein relate to a non-transitory computer-readable medium that stores a set of instructions for wireless communication by a second network node. The set of instructions, when executed by one or more processors of the second network node, may cause the second network node to receive, from a first network node, a message including a request for channel characterization data associated with a UE. The set of instructions, when executed by one or more processors of the second network node, may cause the second network node to transmit, to the first network node, a message including the channel characterization data associated with the UE, wherein the channel characterization data includes measurement information associated with a set of measurements associated with the UE.

Some aspects described herein relate to an apparatus for wireless communication. The apparatus may include means for transmitting, to a network node associated with a DT service, a message including a request for channel characterization data associated with a UE. The apparatus may include means for receiving, from the network node, a message including the channel characterization data associated with the UE, wherein the channel characterization data includes measurement information associated with a set of measurements associated with the UE.

Some aspects described herein relate to an apparatus for wireless communication. The apparatus may include means for receiving, from a network node, a message including a request for channel characterization data associated with a UE. The apparatus may include means for transmitting, to the network node, a message including the channel characterization data associated with the UE, wherein the channel characterization data includes measurement information associated with a set of measurements associated with the UE.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antennas, radio frequency chains, power amplifiers, modulators, buffers, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-3F are diagrams illustrating examples associated with digital twin-assisted channel characterization.

FIG. 4 is a diagram illustrating an example process performed, for example, at a first network node or an apparatus of a first network node.

FIG. 5 is a diagram illustrating an example process performed, for example, at a second network node or an apparatus of a second network node.

FIGS. 6-7 are diagrams of example apparatuses for wireless communication.

### DETAILED DESCRIPTION

In a wireless network, channel state knowledge may be utilized for timely and efficient channel precoding, modulation, and codeword selection, in both uplink (UL) and downlink (DL) wireless communications. In some examples, channel state knowledge may be informed by channel estimation data that is based on measurements obtained from communications between devices in the wireless network. For example, in DL channel estimation, the wireless network may utilize DL pilot signals to obtain user equipment (UE) feedback (e.g., channel state information (CSI) feedback) based on observations of a CSI reference signal (CSI-RS) transmitted from a network node. Similarly, DL channel estimation may utilize UL pilot signals for network-node-based reciprocal channel estimation via antenna-switched channel sampling using a sounding reference signal (SRS) or using time division duplex (TDD) communications with reciprocity conditions. Additionally, UL channel estimation may utilize UL pilot signals that include precoded or unprecoded SRS-based channel sampling, or may utilize a synchronization signal block (SSB) to assist in selection of a UE random access channel (RACH) for channel sampling.

Channel estimation may be utilized for antenna precoding (e.g., precoding associated with the UE or the network node), channel selection (e.g., a network node may utilize channel estimation for cell or carrier selection decisions), or in a broadcast codebook (e.g., selecting SSB beams for initial acquisition), among other examples. Additionally, channel estimation may be utilized for selection of a codebook, a modulation configuration, or a codeword, among other examples.

However, channel estimation procedures may result in increased network overhead, increased energy consumption, or potential difficulty in observing spatial dimensions in a wireless network. For example, channel estimation may require frequent channel measurements and transmission of channel state reports to ensure the continued validity of precoders. For example, where a UE moves at an increasing velocity through a wireless network, the coherence time may drop, which may lead to an increased need for channel sampling. Similarly, environments with a relatively high density of UEs or with a massive multiple-input multiple-output (MIMO) deployment may increase the quantity of channel samples obtained (e.g., decreasing the time period between obtaining samples).

Additionally, in some examples, where a quantity of transceiver units (TRUs) is lower than the quantity of antenna ports, only a limited number of spatial dimensions may be observed. In some examples, the wireless network may configure network components to turn radio frequency front end (RFFE) or TRU components off during appropriate time periods (e.g., a relatively low quantity of payloads) in order to conserve network and energy resources. However, such a configuration may result in a reduction of network observations at the RFFE or TRU components, thereby resulting in potentially diminished network performance (e.g., due to decreased channel estimation instances).

Various aspects relate generally to utilizing a digital twin (DT) service to obtain channel characterization data associated with a component of a wireless network. Some aspects more specifically relate to a first network node transmitting, to a second network node associated with the DT service, a request for channel characterization data associated with a UE. Additionally, the second network node may transmit, to the first network node, the channel characterization data, including measurement information associated with the UE. In some aspects, the measurement information may be associated with a set of measurements associated with the UE. Additionally, in some aspects, the channel characterization data may include at least one of distribution information or aggregation information, associated with the set of measurements. In some aspects, the measurement information may include a time stamp associated with each measurement of the set of measurements.

Particular aspects of the subject matter described in this disclosure can be implemented to realize one or more of the following potential advantages. In some examples, the described techniques can be used to enable channel sampling without utilizing measurements or over-the-air (OTA) overhead resources between one or more network nodes, UEs, or other network components. Additionally, utilizing a DT service may increase observability of components (e.g., endpoints) in the wireless network, for which the network nodes, UEs, or other network components may be unable to sample. For example, the DT service may sample all antenna patches available to the DT service for a hybrid or an analog RFFE architecture. In contrast, the network nodes, UEs, or other network components may be limited to sampling only a subset of antenna patches, due to overhead, energy (e.g., battery), or technological limitations. Furthermore, in some examples, by utilizing the DT service to sample channels, the wireless network may configure network components to maintain RFFE and TRU components in a low energy state, while continuing to sample channels via the DT service.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

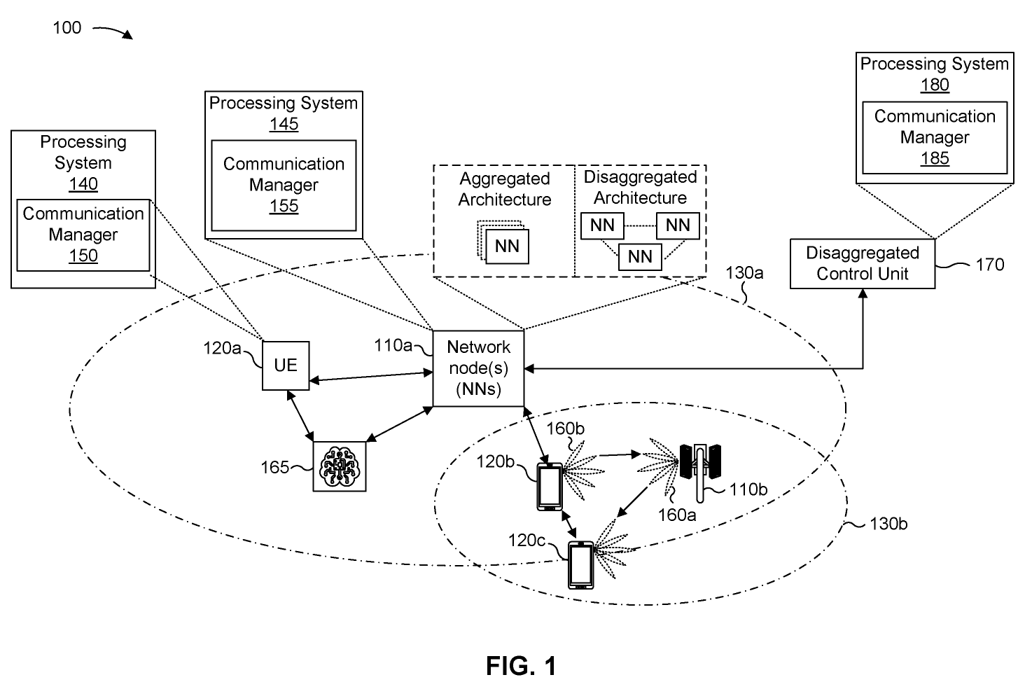

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110. For example, as described herein, a network node 110 may communicate directly with a core network via a backhaul link, or may communicate indirectly with the core network via one or more disaggregated control units 170, such as a Service Management and Orchestration (SMO) system, a RAN intelligent controller (RIC), a non-real-time (non-RT) DT component, a near-RT DT component, or a self-organizing network (SON) component, among other examples.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140, the processing system 145, or the processing system 180) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140, the processing system 145, and the processing system 180 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140, the processing system 145, and the processing system 180 may each include or be coupled with one or more modems (such as a cellular (for example, a 5G or 6G compliant) modem). In some examples, one or more processors of the processing system 140, the processing system 145, or the processing system 180 may include or implement one or more of the modems. The processing system 140, the processing system 145, and the processing system 180 also may include or be coupled with multiple radios (collectively “the radio”), multiple RF chains, or multiple transceivers, each of which may in turn be coupled with one or more of multiple antennas. In some examples, one or more processors of the processing system 140, the processing system 145, or the processing system 180 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140, by the processing system 145, or the processing system 180).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle OTA communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a CSI -RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more disaggregated control units 170, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), a disaggregating control unit 170 (e.g., for example, by the processing system 180), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110 or a disaggregated control unit 170). In other examples of coordinated AI/ML or native AI/ML, a first AI/ML model may be deployed at a UE 120 and a second AI/ML model may be deployed at a network node 110 or a disaggregated control unit 170. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the first network node (e.g., network node 110) may include a communication manager 155. As described in more detail elsewhere herein, the communication manager 155 may transmit, to a second network node associated with a DT service, a message including a request for channel characterization data associated with a UE 120; and receive, from the second network node, a message including the channel characterization data associated with the UE 120, wherein the channel characterization data includes measurement information associated with a set of measurements associated with the UE 120. Additionally, or alternatively, the communication manager 155 may perform one or more other operations described herein.

In some aspects, the second network node (e.g., disaggregated control unit 170) may include a communication manager 185. As described in more detail elsewhere herein, the communication manager 185 may receive, from a first network node, a message including a request for channel characterization data associated with a UE 120; and transmit, to the first network node, a message including the channel characterization data associated with the UE 120, wherein the channel characterization data includes measurement information associated with a set of measurements associated with the UE 120. Additionally, or alternatively, the communication manager 185 may perform one or more other operations described herein.

In some aspects, the UE 120 may include a communication manager 150, which may perform one or more operations described herein.

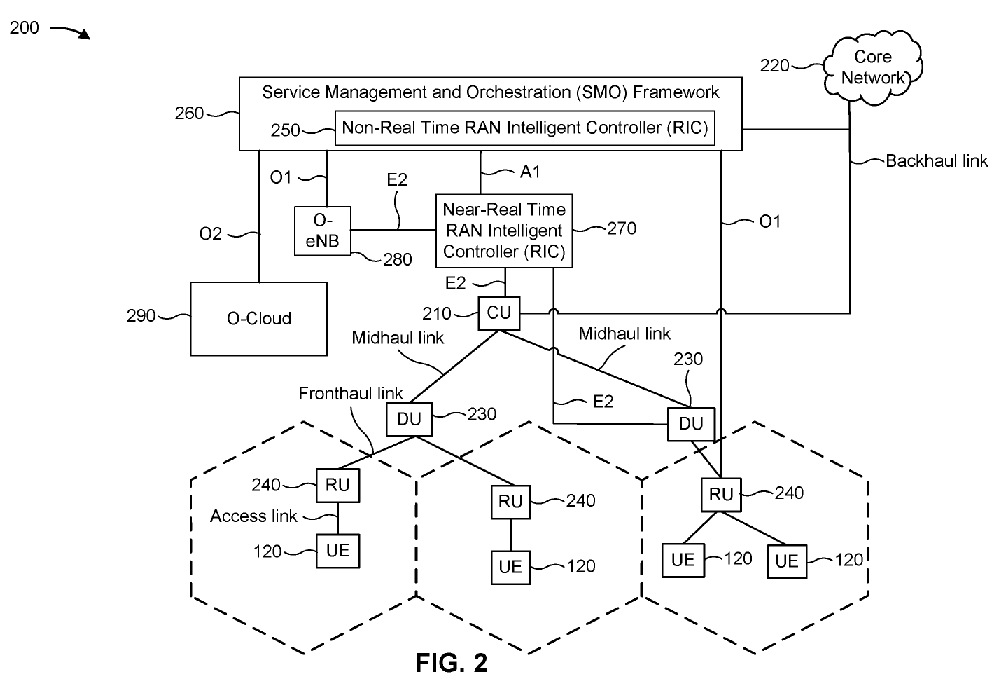

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (non-RT) RAN intelligent controller (RIC) 250 associated with an SMO Framework 260 or a near-real-time (near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the near-RT RICs 270, the non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The non-RT RIC 250 may include or may implement a logical function that enables non-real-time control and optimization of RAN elements and resources, AI/ML workflows including model training and updates, or policy-based guidance of applications or features in the near-RT RIC 270. The non-RT RIC 250 may be coupled to or may communicate with (such as via an A1 interface) the near-RT RIC 270. The near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the near-RT RIC 270.

In some aspects, to generate AI/ML models to be deployed in the near-RT RIC 270, the non-RT RIC 250 may receive parameters or external enrichment information from external servers. Such information may be utilized by the near-RT RIC 270 and may be received at the SMO Framework 260 or the non-RT RIC 250 from non-network data sources or from network functions. In some examples, the non-RT RIC 250 or the near-RT RIC 270 may tune RAN behavior or performance. For example, the non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

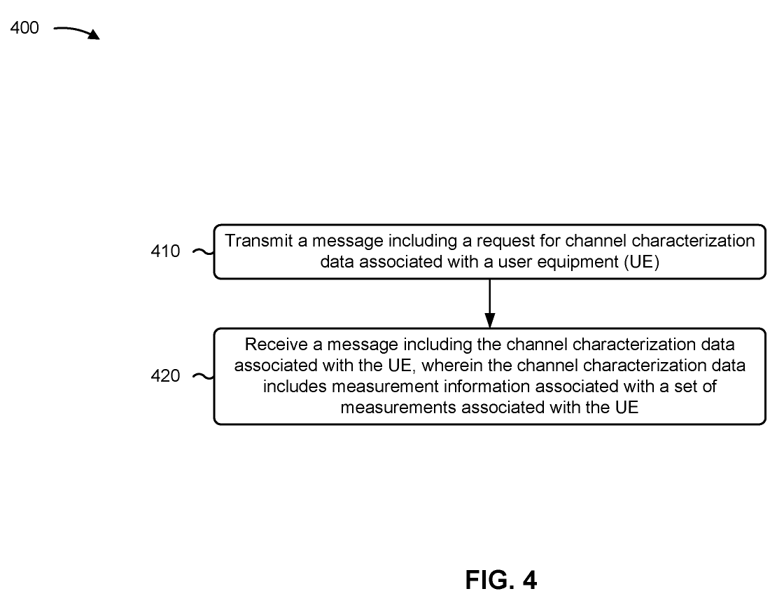

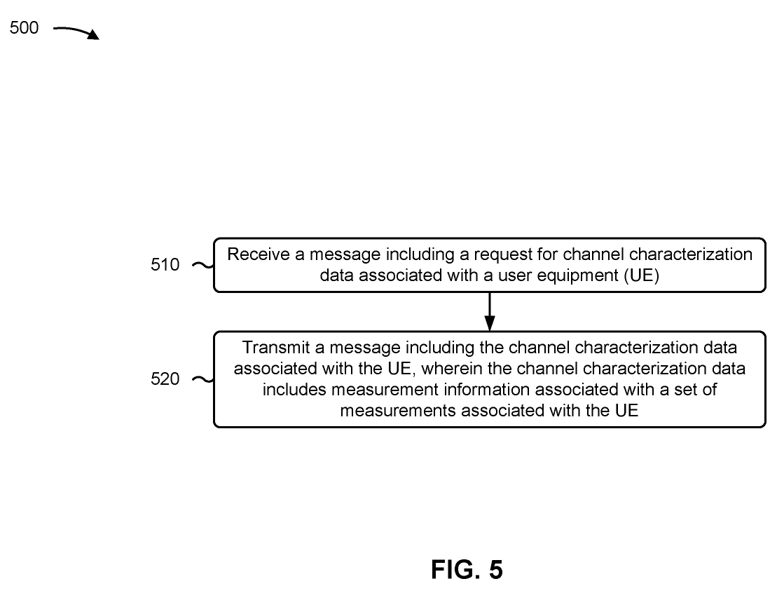

The network node 110, the processing system 145 of the network node 110, the UE 120, the processing system 140 of the UE 120, the processing system 180 of the disaggregated control unit 170, the CU 210, the DU 230, the RU 240, or any other component(s) of FIG. 1 or FIG. 2 may implement one or more techniques or perform one or more operations associated with DT-assisted channel characterization, as described in more detail elsewhere herein. For example, the processing system 145 of the network node 110, the processing system 140 of the UE 120, the processing system 180 of the disaggregated control unit 170, the CU 210, the DU 230, or the RU 240 may perform or direct operations of, for example, process 400 of FIG. 4, process 500 of FIG. 5, or other processes as described herein (alone or in conjunction with one or more other processors). In some aspects, the first network node described herein is the network node 110, is included in the network node 110, or includes one or more components of the network node 110 shown in FIG. 1. In some aspects, the second network node described herein is the disaggregated control unit 170, is included in the disaggregated control unit 170, or includes one or more components of the disaggregated control unit 170 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of the network disaggregated control unit 170 may store data and program code (or instructions) for the disaggregated control unit 170, network node 110, the CU 210, the DU 230, or the RU 240. Memory of a UE 120 may store data and program code (or instructions) for the UE 120, such as context information. In some examples, the memory of the UE 120, the memory of the disaggregated control unit 170, or the memory of the network node 110 may include a non-transitory computer-readable medium storing a set of instructions for wireless communication. For example, the set of instructions, when executed by one or more processors (for example, of the processing system 145, the processing system 140, or the processing system 180) of the network node 110, the UE 120, the disaggregated control unit 170, the CU 210, the DU 230, or the RU 240, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

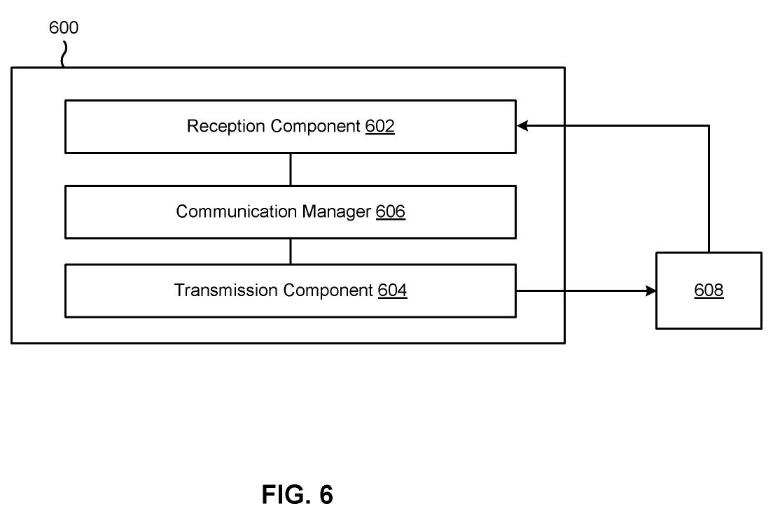

In some aspects, the first network node (e.g., network node 110) includes means for transmitting, to a second network node associated with a DT service, a message including a request for channel characterization data associated with a UE 120; or means for receiving, from the second network node, a message including the channel characterization data associated with the UE 120, wherein the channel characterization data includes measurement information associated with a set of measurements associated with the UE 120. The means for the first network node to perform operations described herein may include, for example, one or more of communication manager 155, processing system 145, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

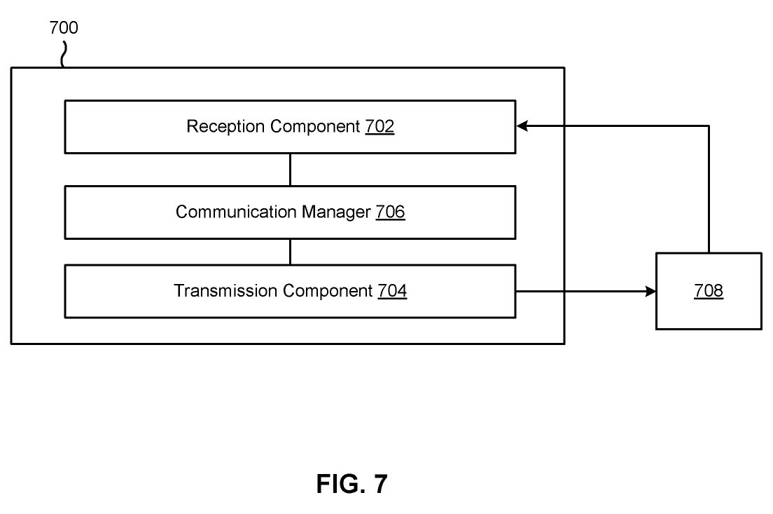

In some aspects, the second network node (e.g., disaggregated control unit 170) includes means for receiving, from a first network node, a message including a request for channel characterization data associated with a UE 120; or means for transmitting, to the first network node, a message including the channel characterization data associated with the UE 120, wherein the channel characterization data includes measurement information associated with a set of measurements associated with the UE 120. The means for the second network node to perform operations described herein may include, for example, one or more of communication manager 185, processing system 180, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

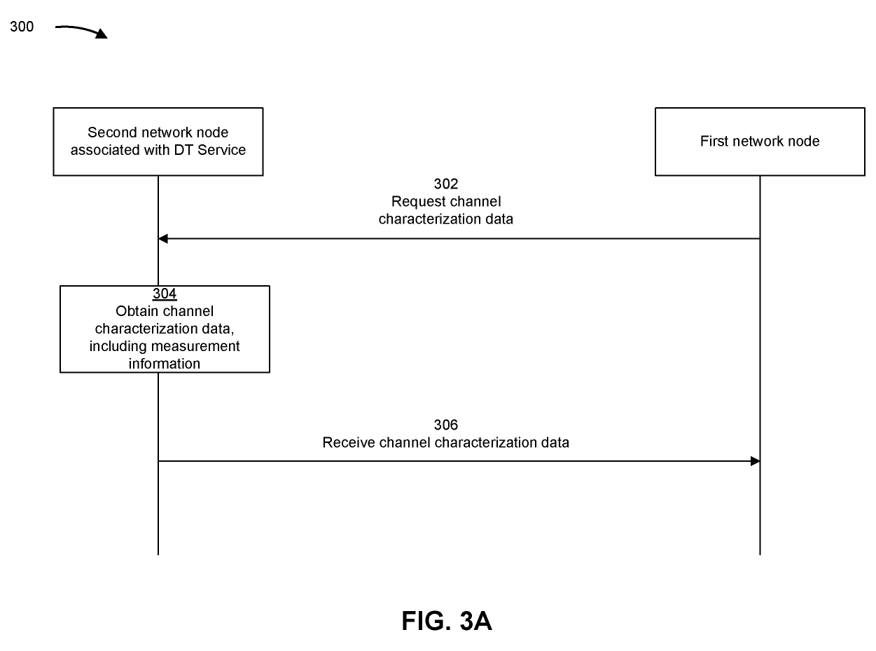

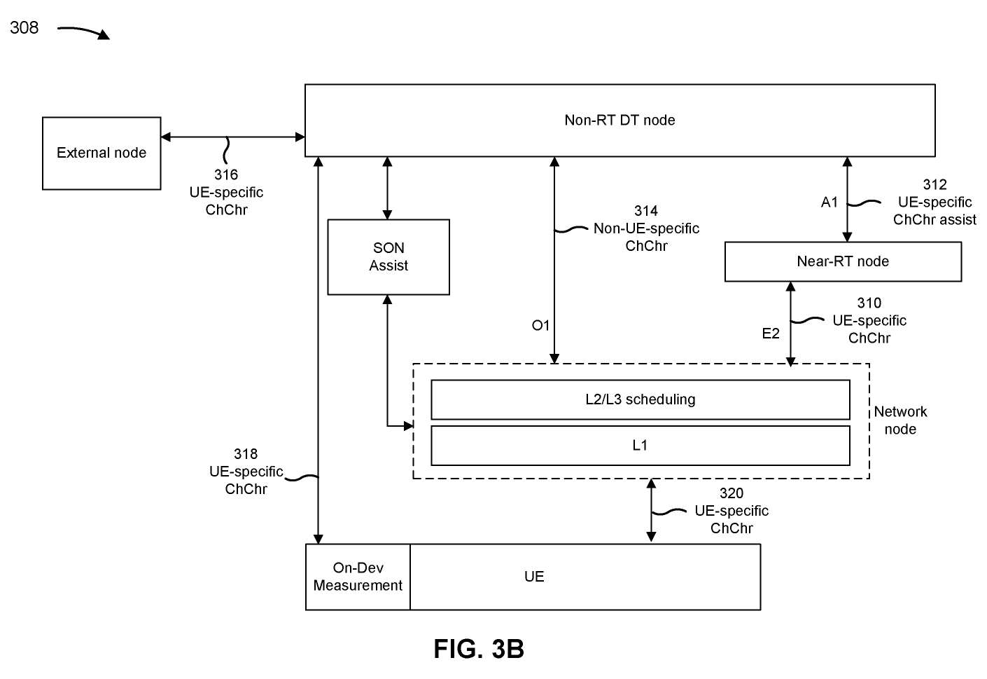

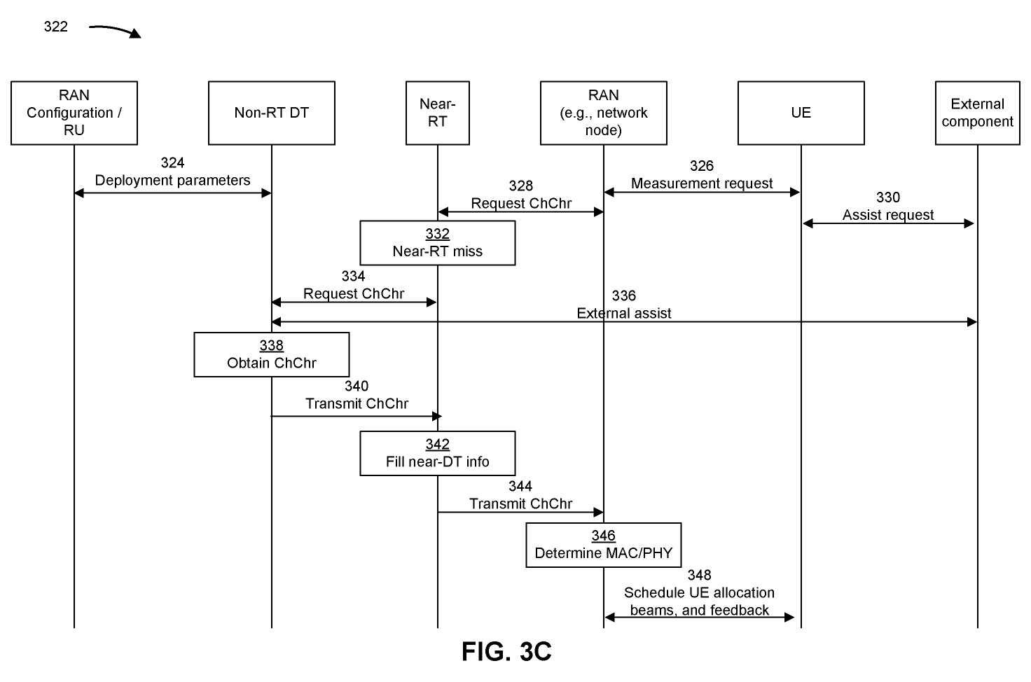

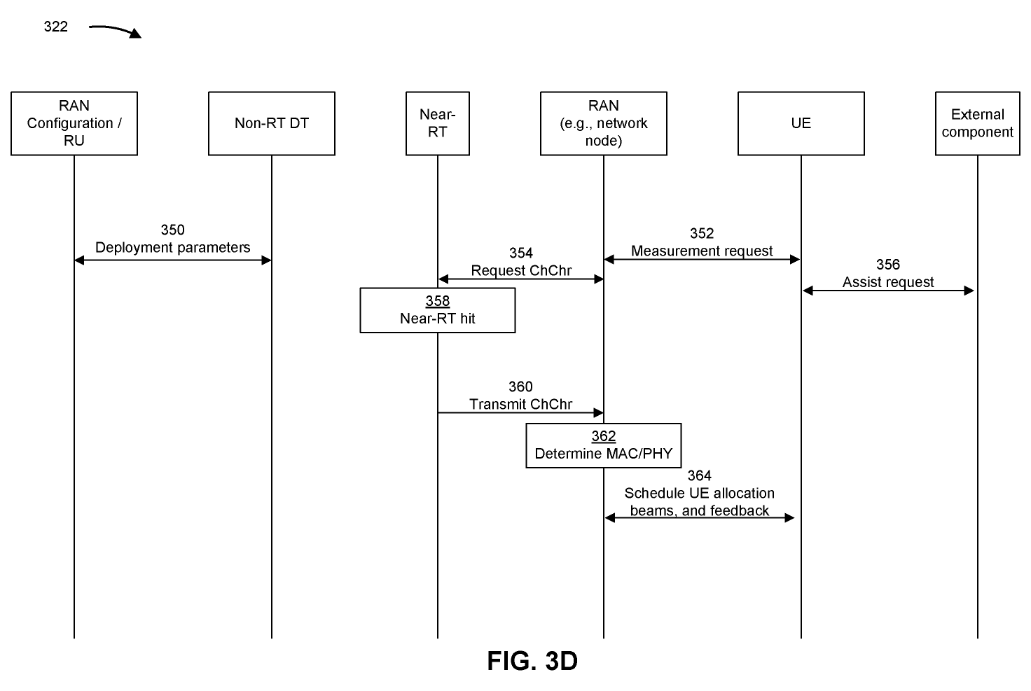

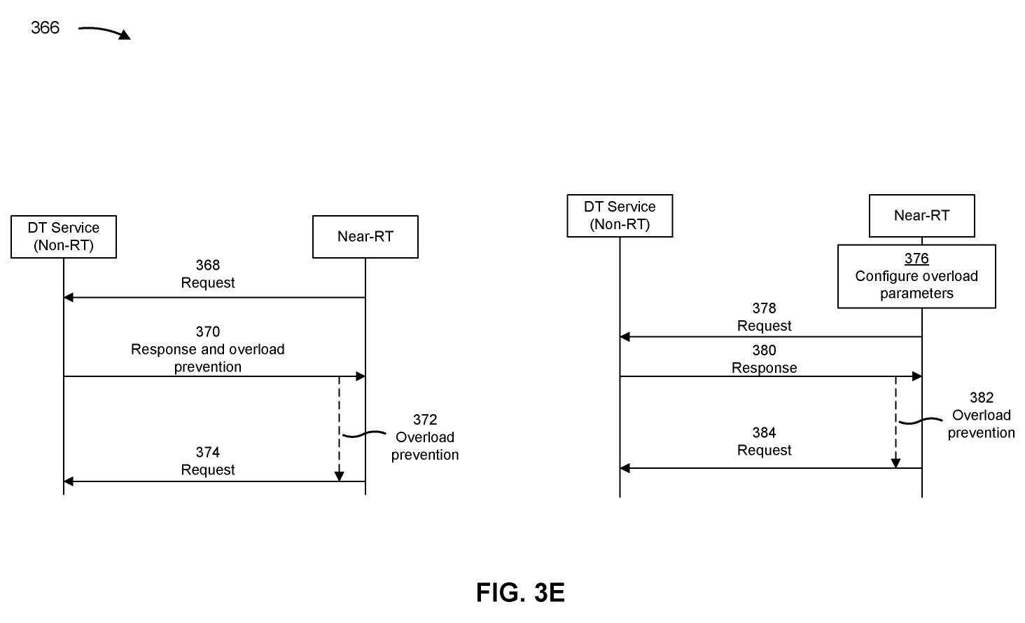

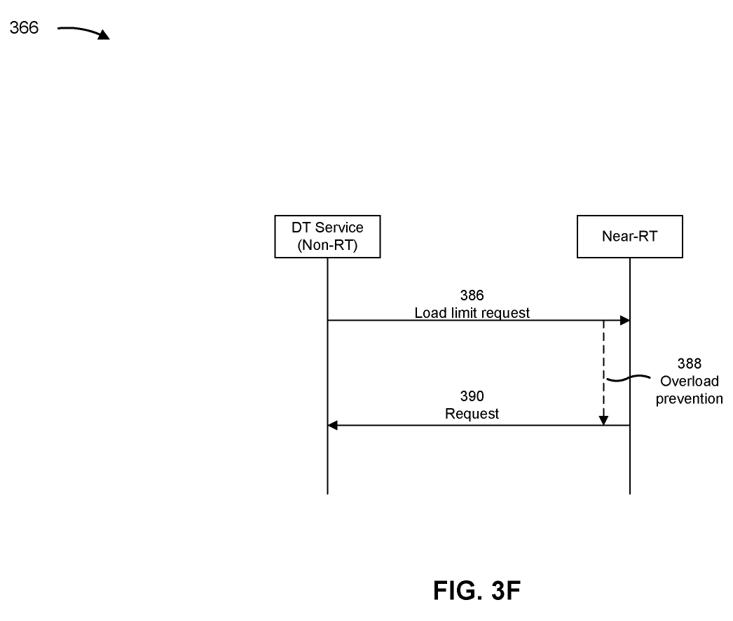

FIGS. 3A-3F are diagrams illustrating examples 300, 308, 322, and 366 associated with DT-assisted channel characterization. As shown in FIG. 3A, example 300 includes communication between a first network node (e.g., a network node 110 or a RAN component, among other examples) and a second network node associated with a DT service (e.g., a non-RT DT component). In some aspects, the DT service may be associated with a representation (e.g., a digital representation, a virtual representation, or the like) of a wireless propagation environment (e.g., a wireless network). The representation may be used to provide channel characterization insights associated with the complementary (e.g., real-world) components of a wireless network. For example, the DT service may be utilized to perform channel sampling of a UE within the digital representation of the wireless propagation environment, thereby avoiding channel sampling using one or more real-world network components.

In some aspects, the first network node and the second network node may be included in a wireless network, such as wireless network 100. Additionally, or alternatively, the first network node and the second network node may communicate via a wireless access link, which may include a UL and a DL.

As shown by reference number 302, the first network node may transmit, and the second network node may receive, a message including a request for channel characterization data associated with a UE or one or more additional network components. In some aspects, the request may include an endpoint, which may be one or more identifiers or entities that are associated with characterization information or endpoint state information for the digital subject of measurement (e.g., the UE). For example, the identifier may include an international mobile subscriber identity (IMSI), an international mobile equipment identity (IMEI), a MAC identifier (ID), a cell ID, a hardware ID, or the like, which may be mapped to a real-world or virtually-represented measurement point (e.g., an antenna). Additionally, the characterization data may include technology information (e.g., associated with a wireless telecommunications standard), architecture information (e.g., four transmit, four receive (4T4R) architecture), or location information (e.g., global information system (GIS) information, location control server (LCS) information, or the like), among other examples, associated with the digital subject of measurement. Furthermore, the endpoint state information may include information associated with discontinuous reception (DRX), battery state, device information (e.g., in-pocket), or energy state, among other examples, associated with the digital subject of measurement.

In some aspects, the request may include a measurement scope that may be associated with one or more wireless communication standards. For example, the measurement scope may include information associated with a band, a frequency, a beam, a set of beams, a set of paths, a light detecting and ranging (LiDAR) sensor, an in-device coexistence (IDC) state observer, a power amplifier, an additive gain component, a set of UEs being served, or a set of profiles, among other examples, associated with the digital subject of measurement.

In some aspects, the request may include a framework that characterizes the endpoint or the measurement scope. For example, the framework may include an antenna configuration, a set of logical observation ports, a waveform configuration, or a filter for measurement, averaging, inclusion, or processing observations, among other examples. Additionally, the framework may include a report characterization for the types of information that may be transmitted in a report (e.g., including channel characterization data), from the second network node, in response to the request. For example, the report characterization may include a format configuration (e.g., codebook index, explicit metrics, compression information), a metric-type configuration (e.g., received energy, quality, signal-to-noise ratio (SNR), signal-to-interference-plus-noise ratio (SINR), noise, interference), or restrictions (e.g., rank limitation, coherence limitation, overall report size, maximum compression), among other examples.

In some aspects, the request may include one or more reporting conditions that may characterize the time associated with one or more measurements associated with the digital subject of measurement (e.g., the UE). For example, a reporting condition may include a set of thresholds or threshold parameters (e.g., a period, a delay, hysteresis configurations, or the like) that determine whether the second network node reports, to the first network node, information associated with the requested channel characterization data. In some aspects, the thresholds or thresholds associated with one or more parameters may be directly or indirectly based on a wireless channel characterization (e.g., a threshold in signal quality) or one or more additional parameters (e.g., a change in the DT environment, including an appearance of a new component, a state change, or an overheating condition associated with the UE). Similarly, a threshold associated with the one or more parameters may be satisfied by a configuration (e.g., an initial setup of a component) or by an aggregation of parameters (e.g., a change in a distribution of antennas or devices that satisfies a threshold). The reporting condition may be associated with a causal or a non-causal condition, including an anticipated condition or a future time.

In some aspects, the request may include information associated with a session for communication between the first network node and the second network node or among the first network node, the second network node, and one or more additional network components. For example, the request may include session information associated with initiation of a session for transmitting a plurality of requests associated with channel characterization data. Additionally, or alternatively, the first network node may transmit requests for channel characterization data on independent bases (e.g., on a request-by-request basis). In some aspects, the request may include a set of identifiers that identify one or more of the endpoint, the measurement scope, the framework, or the reporting condition associated with the session. Additionally, each identifier, of the set of identifiers, may be unique to each endpoint, measurement scope, framework, or reporting condition within the session.

As shown by reference number 304, the second network node associated with the DT service may obtain channel characterization data including measurement information, in response to the request for channel characterization data, as described herein. For example, the second network node may obtain a set of measurements associated with the UE, and the set of measurements may be included in the measurement information associated with the channel characterization data.

As shown by reference number 306, the second network node associated with the DT service may transmit, and the first network node may receive, channel characterization data associated with the UE (e.g., the digital subject of measurement). In some aspects, the channel characterization data may include measurement information associated with a set of measurements associated with the UE.

In some aspects, the set of measurements may include information associated with a set of paths, a set of beams, a set of in-phase or quadrature phase (IQ) observations, or a set of aggregate measurements taken over the paths, beams, or IQ observations, among other examples. Additionally, the channel characterization data may include a distribution (e.g., a probability mass function) associated with the set of measurements. In some aspects, the channel characterization data may include an aggregation associated with the set of measurements, and the aggregation may include an aggregation over coherence time, coherence bandwidth, paths, beams, antennas, or endpoints, among other examples. The aggregation may be associated with an implied aggregation level (e.g., the DT service may derive a coherence resolution) or an explicit aggregation level (e.g., aggregation over a specific metric or over an interval of a metric). Additionally, the aggregation may be performed according to an aggregation mechanism, including a linear or geographic averaging metric, one or more metric thresholds (e.g., a maximum threshold or a minimum threshold), a counting threshold, or the like.

In some aspects, the channel characterization data may include a time stamp associated with the measurement information. For example, the channel characterization data may include a time stamp associated with each measurement, of the set of measurements, included with the measurement information. In some aspects, the time stamp may be associated with a previous time or a future time. For example, a time stamp may be associated with one or more events that the DT service predicts (e.g., according to an AI/ML model, as described herein) to occur. In some aspects, the time stamp may be explicitly indicated, and the explicit indication may include resolution information associated with the time stamp. Additionally, or alternatively, the time stamp may be implicitly indicated, where the time stamp may be associated with a measurement taken within a time period before the channel characterization data was transmitted to the first network node.

In some aspects, the channel characterization data may include path information associated with a set of paths. For example, the path information may be utilized for point-to-point ray tracing procedures. In some aspects, the path information may include information associated with one or more endpoints associated with the set of paths. For example, the path information may include antenna aggregation information, indicating aggregation over one or more antennas or observation points, and the endpoint may correspond to a real-world deployment or a virtually-represented deployment. In some aspects, the path information may include, for each path of the set of paths, amplitude or gain information (e.g., absolute or relative information), angular spread information (e.g., mean angle, angular distribution, threshold values, or the like), delay spread information (e.g., including mean, spread, distribution, or threshold information), phase distribution information, Doppler distribution information, or one or more additional or equivalent physical or radio frequency metrics (e.g., coherence time), among other examples.

In some aspects, the channel characterization data may include beam information associated with a set of beams. For example, the beam information may be utilized for point-to-point ray tracing procedures. In some aspects, the beam information may indicate a quantity of beam objects (e.g., a (beam, antenna) pair, a (beam, beam) pair, or a (beam, aggregate receiver) pair, among other examples). In some aspects, the beam information may identify a beam, of the set of beams, as one or more of a codeword (e.g., a codeword index), a set of port weights, a characterization (e.g., an azimuth or an elevation), a radiation pattern, an implicit (e.g., DFT) codebook, an explicit (e.g., preconfigured or derived) codebook, or a set of conditions or thresholds, among other examples. Additionally, for each beam, the beam information may include amplitude or gain information, delay information, or Doppler distribution information, among other examples.

In some aspects, the request may be associated with one or more profile configurations indicating one or more data types to be included in the channel characterization data. For example, a profile configuration may restrict or qualify (e.g., via gating or aggregating measurements over endpoints) the types of data included in the channel characterization data. For example, an “energy savings” profile may instruct the second network node to restrict measurements to certain antennas in order to obtain metrics associated with those antennas. In some aspects, the profile configuration may be determined by the second network node or may be determined (e.g., in-whole or in-part) by an external component. For example, the request from the first network node may instruct the second network node to obtain a profile configuration. Furthermore, the second network node may be instructed to request that an external component (e.g., a SON component) select the profile configuration to be used at the second network node.

Additionally, or alternatively, in some aspects, an external entity (e.g., an entity other than the first network node, including an M-Plane client, among other examples) may request that the second network node obtain channel characterization data or transmit channel characterization data to the first network node. Similarly, in some aspects, an external entity may request that the first network node transmit, to the second network node, the request for channel characterization data. In some aspects, the second network node may obtain a configuration that instructs the second network node to obtain channel characterization data or transmit channel characterization data to the first network node. In some aspects, the second network node may initiate the process of obtaining channel characterization data or transmitting channel characterization data to the first network node, independently of the request transmitted from the first network node to the second network node. In some aspects, the second network node may initiate the process of obtaining channel characterization data or transmitting channel characterization data to the first network node as part of a DT calibration procedure.

In some aspects, the second network node may indicate, to the first network node, that the second network node is unable to fulfill the request for channel characterization data or that the second network node is able to partially fulfill the request for channel characterization data. For example, the second network node may indicate that CSI information could only be provided up to rank 2 or that the UE position could not be determined, among other examples. In some aspects, the second network node may indicate, to the first network node, one or more corrective actions associated with information that the second network node was unable to obtain in fulfilling the request for channel characterization data. For example, the second network node may request that the first network node provide an updated UE location or orientation information associated with the UE. Similarly, for example, the second network node may request that the first network node limit the number of requests or transmit requests according to a periodicity, in order to address one or more load conditions at the second network node.

In some aspects, the second network node may indicate, to the first network node, an accuracy indicator associated with the channel characterization data that is transmitted to the first network node. For example, the accuracy indicator may include information associated with a measurement accuracy likelihood (e.g., a percentage likelihood associated with accuracy metrics), a measurement resolution, or a noise assumption, among other examples, associated with the measurement information included in the channel characterization data. Additionally, or alternatively, the second network node may indicate, to the first network node, one or more external conditions that resulted in the second network node being unable to fulfill the request from the first network node. For example, where the request is related to weather information, the second network node may indicate that it is unable to fulfill the request due to a weather service (e.g. a source of weather information) experiencing a temporary outage.

In some aspects, the channel characterization data may be based on sampling of virtual nodes (e.g., a virtual network node or a virtual UE). In some aspects, the subject of measurement may be a virtual representation of a component (e.g., a virtual UE or a hypothetical representation of a DT UE with a non-twin configuration or a non-twin RAN component) rather than a real-world component. For example, the first network node may request channel characterization data for a virtual node (e.g., a virtual UE) that exists solely as a virtual representation (e.g., without a real-world complement).

In some aspects, the measurement information associated with the channel characterization data may be translated from a first data type to a second data type. Additionally, or alternatively, the channel characterization data may be translated prior to being transmitted to the first network node. For example, the sampled metrics associated with the UE (e.g., the subject of measurement) may not be compatible (e.g., may not match) the metrics associated with the second network node (e.g., the channel characterization data type or format). For example, the channel characterization data may characterize data according to path information, whereas sampled measurement information may be expressed as beam-level reports (e.g., CSI feedback). Accordingly, in some aspects, the second network node, the first network node, or one or more additional components may perform a protocol translation of the measurement information. For example, the second network node or one or more additional components may accommodate a derivation channel characterization in a form or type that is compatible with an end node (e.g., the first network node), based at least in part on the channel characterization data. For example, the derivation may utilize metrics originating outside of the measurement information obtained by the DT service (e.g., past observations obtained at the first network node or at the UE). In some aspects, the protocol translation may be subject to additional provisioning, including model selection, calibration, or state management, among other examples. In some aspects, the protocol translation may be performed locally at the first network node. In some aspects, the function performing the protocol translation may be separate or independent from the functions associated with transmitting the request for channel characterization data, obtaining channel characterization data, or transmitting channel characterization data.

In some aspects, the second network node (e.g., the DT service or a cache associated with the DT service) may communicate with one or more external components (e.g., a weather service or a location control server, among other examples) in order to obtain measurement information associated with channel characterization. For example, the measurement information may include measurement information that is inaccessible by the first network node. In some aspects, the communications with one or more external components may be with UE-specific or non-UE-specific sources. For example, the second network node may request weather information, traffic information, particle pollution, spectrum allocation, network listen information, drive test information, wireless or non-wireless infrastructure construction or maintenance information, emergency information, event information, product specifications, product update or upgrade information, or the like, that may be specific to the UE or may be associated with one or more UEs, and that may be inaccessible to the first network node. In contrast, the second network node may obtain position information, orientation information, state information (e.g., battery state), RF change information (e.g., attenuation information), damage information, after-market additions, or the like, that is specific to the UE. For example the external components may be associated with one or more of a weather service, a traffic service, a positioning server, a database (e.g., maintained by a modem vendor, an original equipment manufacturer (OEM), a wireless network operator, a third-party vendor, or the like), sensing servers (e.g., an integrated sensing and communication (ISAC) server), GIS servers, or deployment-assist servers (e.g., an automated frequency coordination (AFC) server), among other examples.

In some aspects, the measurement information may be obtained from the external component based on one or more conditions being satisfied. For example, the DT service may obtain measurement information (e.g., channel estimation information) from the external component upon receiving a request for channel characterization data (e.g., including a channel estimation request). Similarly, the DT service may obtain measurement information from the external component according to a parallel update function (e.g., periodically obtaining updated weather information) or according to external conditions (e.g., environmental changes that may impact the virtual representation consistency or the first network node reporting an observed inconsistency associated with the virtual representation, among other examples). Additionally, or alternatively, the conditions may be configured according to one or more UE-specific or non-UE-specific configuration scopes. For example, the scope of UE-specific conditions may be limited to measurement information associated with specific antennas, specific locations, specific configurations, or the like. Similarly, for example, the scope of non-UE-specific conditions may be limited to measurement information associated with a specific network node, a specific object (e.g., a digitally-represented object with a real-world complement), a virtual object (e.g., an object represented only in a digital form within a virtual environment), or entities (e.g., software components, drivers, or hosting cloud architecture), among other examples.

Additionally, or alternatively, the second network node (e.g., the DT service or the cache associated with the DT service) may communicate with the first network node in order to obtain measurement information associated with channel characterization. As a result, the DT service may obtain up-to-date deployment information associated with the UE, and portions of associated measurement information may be obtained from the first network node or from the external component.

In some aspects, a DT-SON may interact with the second network node (e.g., with the DT service), the first network node, or one or more additional network components. In some aspects, the DT-SON may collect data from both the first network node and the second network node to optimize configurations and operations associated with the first network node. For example, the DT-SON may be utilized for cell-shaping (e.g., in MIMO deployments) by determining an optimal SSB beam codebook associated with a network node carrier or sector. In some aspects, the DT-SON may be independent of a centralized SON (C-SON), a distributed SON (D-SON), or a hybrid SON, and the DT-SON may operate in a centralized, distributed, or hybrid configuration.

In some aspects, the DT-SON may utilize or communicate with one or more APIs associated with the DT service, while accounting for hybrid antenna array architectures associated with one or more wireless communication standards. In some aspects, the DT-SON (e.g., including associated functions) may be separate from the first network node or the second network node. For example, the DT-SON may interact with the second network node in a manner that is similar to the first network node’s interaction with the second network node (e.g., the DT-SON may obtain UE-specific channel characterization data from the second network node). Similarly, for example, the DT-SON may interact with the first network node in a manner that is similar to the second network node’s interaction with the first network node (e.g., the DT-SON may obtain measurement information from the first network node). In some aspects, the DT-SON may interact with the first network node as a management function (e.g., an operation and management (OAM) function, an M-Plane client for reconfiguration network node functions or network nodes, or the like).

Additionally, in some aspects, the DT-SON (e.g., the DT-SON function) may be co-located or identified as associated with the second network node (e.g., the DT service may provide SON functionality to the first network node), with the first network node (e.g., the first network node may perform SON functions utilizing measurement information obtained by the DT service), or with an OAM associated with the first network node (e.g., to update a RAN configuration, to meet targets associated with the DT-SON, or the like), among other examples. In some aspects, the DT-SON (e.g., the DT-SON function) may utilize or may bypass some or all near-RT DT functions or nodes (e.g. a non-RT DT SON may be co-located with the DT service). For example, the DT-SON may utilize near-RT DT functions or may bypass near-RT DT functions in communicating with a network node, the non-RT DT, or one or more additional network components.

In some aspects, the DT-SON (e.g., the DT-SON function) may obtain or sample observations (e.g., measurement information) associated with the DT service, and the DT-SON may attach complementary metrics observable to the DT service (e.g., that may be unavailable from measurements at the first network node). In some aspects, the complementary metrics observable to the DT service may include a physical (e.g., real-world) twin classification associated with a location (e.g., “corridor,” “office,” or the like), a UE label (e.g., “OEM,” “in a case,” “compromised antenna,” or the like) a UE state (e.g., “taking photos,” running a specific app, “in pocket,” or the like), environment (e.g., “raining,” “heavy traffic,” or the like). In some aspects the classification of such complementary metrics may be automated (e.g., at a network node). In some aspects, the DT-SON may obtain such observations in order to satisfy one or more parameter goals. For example, a parameter goal may be associated with a codebook of SSB beams, beams for CSI-RS virtual ports, SSB order, electronic or mechanical tilt, beams for hierarchical beam management (e.g., for P1, P2, or P3 steps), a set of antennas, carrier information, radio unit information, TRU or cell on/off priorities associated with energy saving goals, a calibration parameter, or a set of cell locations, among other examples.

In some aspects, the DT-SON may be configured to obtain information associated with a set of characteristics, a set of conditions, and a set of targets, associated with the one or more parameter goals. For example, the DT-SON may configure virtual digital nodes associated with the DT service to match or to partially match conditions associated with the parameter goal. The DT-SON may determine one or more deployment parameters (e.g., electrical or mechanical tilt, codebook of SSB beams, SSB order, hierarchy of P1, P2, or P3 beams, or the like) that may be utilized to satisfy the targets (e.g., exceeding a threshold associated with RSRP) for the conditions or deployment restrictions.

In some aspects, the characteristics may include cell locations or potential locations, cell or UE access point antenna geometries, antenna panel size and RFFE hierarchy (e.g., full digital, analog, hybrid fully connected, hybrid partially connected, or an indication of a method of partial connection, among other examples), power amplifier (PA) models, or noise figure information, among other examples. Additionally, in some aspects, the set of conditions may be associated with UE distribution (e.g., density of UEs in a geographic area), traffic patterns, power information (e.g., a maximum power value), a range of mechanical tilts, or UE use cases (e.g., URLLC use cases or eMBB targets), among other examples. In some aspects, the set of conditions may be associated with the complementary metrics. For example, a condition may be associated with a threshold (e.g., 90% of observed UEs located in cafeteria) or with location-specific conditions (e.g., observe only UEs located on a factory floor). Additionally, in some aspects, the targets may include information associated with tail or median pathloss, throughput, latency, or energy-usage targets for one or more UEs or network components, among other examples.

In some aspects, the DT-SON may deploy virtual UEs to match a distribution associated with a prescribed condition, or the DT-SON may deploy scenarios associated with the DT service to evaluate a set of hypotheses associated with one or more conditions (e.g., open/closed doors, UE located in specific locations, or the like).

In some aspects, the DT-SON may utilize one or more thresholds (e.g., associated with one or more parameter goals) to determine whether a target condition is satisfied. For example, a parameter goal may be associated with certain conditions (e.g., a threshold RSRP value and a threshold throughput value associated with UEs located in a cafeteria during a time period), and the DT-SON may utilize complementary DT metrics to determine whether one or more of the conditions are satisfied.

In some aspects, the wireless network may include two DT-SON instances, and each instance may differ in at least one of the DT service and environment utilized (e.g., low resolution network DT service, high resolution cell DT service), the parameter set being optimized (e.g., latency and throughput), or the parameters controlled by the DT-SON instances (e.g., transmit power and SSB codebook). In some aspects, the DT-SON instances may run in parallel or in series, and the DT-SON instances may utilize one or more convergence mechanisms (e.g., gradient descent). For example, a first DT-SON may optimize a set of parameters, which may become the starting parameters for a second DT-SON. The optimized parameters associated with the second DT-SON may then be utilized by the first DT-SON until convergence.

In some aspects, the DT-SON may evaluate metrics that are observed in a real-world environment (e.g., from one or more network components). For example, where a difference between a real-world metric and a metric obtained from a virtual representation (e.g., a virtual environment associated with the DT service) satisfies (e.g., exceeds) a threshold or satisfies one or more conditions, the DT-SON may identify parameters for potential change or calibration. As a result, the virtual representation may be updated to improve the correlation between measurement information associated with the virtual representation metrics and measurement information associated with the real-world components. In some aspects, the DT-SON may transmit one or more identified parameters or potential parameter changes (e.g., calibration parameters) to the DT service.

In some aspects, the DT-SON (e.g., a DT-SON function) may be configured to perform or participate in beam or cell shaping associated with a set of DL or UL beams. In some aspects, the DT-SON may base the cell shaping or beam optimization on the set of complementary metrics associated with the DT service, including location information associated with the UE. In some aspects, the complementary metrics may be utilized to generate the set of characteristics, the set of conditions, and the set of targets, associated with the one or more parameter goals (e.g., each parameter may be explicit or implicitly indicated). Based on feedback (e.g., observations, measurements, or the like), the DT-SON may determine whether one or more conditions associated with beam optimization are satisfied (e.g., a latency threshold is satisfied for access at a programmable logic controller (PLC) location, DL or UL SINR satisfies a threshold for one or more locations, SINR measurements satisfy a measurement threshold, a threshold SINR percentile is satisfied for initial access, or a threshold associated with a CSI-RS configuration is satisfied, among other examples). Additionally, the DT-SON may utilize a set of measurement strategies, including allocating a portion of power to SSB, sweeping a certain quantity of beams for initial access, utilizing a bounded quantity of time domain RACH occasions, or utilizing a bounded quantity of preamble roots across RACH occasions, among other examples. Additionally, the DT-SON may utilize or may be configured with one or more provisioning parameters (e.g., a RAN node semi-static configuration or parameters, including a radiation pattern, or other configurations similar to an open-RU (O-RU) object model).

In some aspects, the DT-SON may perform beam optimization that results in a set of beams (e.g., an ordered set of beams), a set of RACH occasions (e.g., including implicit or explicit RACH beams to correspond to SSB beams), a set of CSI-RS beams (e.g., one set per CSI-RS configuration or per UE group), a hierarchy of P1, P2, or P3 beams, or a set of antenna profiles, among other examples. In some aspects, the DT-SON function may be invoked multiple times or for multiple scenarios. For example, during a time period associated with a lunch event, the DT-SON may be utilized to maximize measurement or observation key performance indicators (KPIs) for UEs located in a cafeteria. Similarly, during a time period that occurs outside of the lunch event time period, the DT-SON may be utilized to maximize measurement or observation KPIs for UEs located in an office (e.g., external to the cafeteria). Additionally, for a time period associated with non-office hours, the DT-SON may be utilized to maximize measurement or observation KPIs associated with security cameras on the office premises.

Additionally, or alternatively, the second network node may obtain UE-specific measurements or configuration measurements that are incompatible with or unsupported in an active OTA protocol. For example, an active wireless protocol may not capture measurement information that the DT service may utilize to generate channel characteristic data. Accordingly, the second network node may obtain such measurement information, which may include UE orientation (e.g., expressed in absolute or relative units), UE state information (e.g., connected, on battery, battery levels, in pocket, held in hand, or the like), or information associated with applications currently in use (e.g., a quality of service identifier, application names, application configurations or conditions, or the like).

In some aspects, the second network node (e.g., including the DT service) may obtain measurement information (e.g., UE-specific measurement information) directly from the second network node, from a third-party service (e.g., a UE database maintained by an OEM), or directly from the UE. For example, the measurement information may be obtained via information associated with an over-the-top (OTT) interaction (e.g., the DT service interacts directly with the UE via an application installed on the UE), Uu, RRC, L2, L1, or the like. Similarly, measurement information obtained from a third-party service may be obtained via the external component in communication with the second network node. Accordingly, by utilizing a DT-SON as part of obtaining and providing channel characterization data, the wireless network may qualify or quantify channel characterization metrics (e.g., measurement information or the like) that may be incompatible or unsupported by the DT service, thereby enabling the wireless network to determine satisfaction of the goal criteria according to labels associated with channel characterization metrics.

As shown in FIG. 3B, example 308 illustrates an example architecture associated with DT-assisted channel characterization. In some aspects, a non-RT DT component may host a DT service associated with obtaining information associated with requested channel characterization data associated with a UE or one or more additional network components.

In some aspects, the non-RT DT component may be in communication with a near-RT node, and the near-RT node may be in communication with a network node. As shown by reference number 310, the network node may transmit, to the near-RT node, a request for channel characterization data associated with the UE (e.g., including measurement information associated with the UE). As shown by reference number 312, the near-RT node may transmit, to the non-RT component, a request for channel characterization data that is associated with the request from the network node, thereby assisting with the request by acting as an intermediary between the non-RT DT node and the network node. As a result, the non-RT DT node may obtain channel characterization data associated with the UE, and the non-RT DT node may transmit the channel characterization data to the network node (e.g., directly, or indirectly via the near-RT node).

As shown by reference number 314, the network node may transmit, to the non-RT DT node, a request for non-UE-specific channel characterization data. The non-RT DT node may obtain the channel characterization data and transmit the channel characterization data to the network node. Additionally, or alternatively, and as shown by reference number 316, the non-RT DT node may obtain, from an external node, all or part of the measurement information associated with the channel characterization data. Additionally, or alternatively, and as shown by reference number 318, the non-RT DT node may obtain, directly from the UE, all or part of the measurement information associated with the channel characterization. Additionally, or alternatively, and as shown by reference number 320, the network node may obtain, directly from the UE, measurement information associated with the channel characterization. Similarly, and as shown by reference number 318, an on-device measurement component (e.g., located on the UE) may request channel characterization data associated with the UE, where the measurement information may be transmitted to one or more additional network components.

In some aspects, the near-RT node (e.g., including a DT function) may be hosted in relatively close proximity to the L2 scheduler, thereby enabling the near-RT node to fulfill requests for channel characteristic data. For example, the requests for channel characterization data may terminate at the near-RT node, which may fulfill the requests. In some aspects, the near-RT node may respond with a “hit,” a “miss,” or a “stale” indication, in response to receiving a request for channel characterization data. For example, the “hit” indicator may indicate that the request may be fulfilled locally at the near-RT. The “miss” indicator may indicate that the near-RT node is unable to fulfill the request, and in some aspects, the near-RT node may obtain the measurement information from the non-RT node and obtain and transmit the channel characterization data to the network node. Additionally, the “stale” indicator may indicate that the request can be partially fulfilled at the near-RT node, and the near-RT node may obtain the missing measurement information from the non-RT node. Additional near-RT response indications may be supported in order to characterize or qualify the channel characterization (e.g. to induce the RAN node to assist DT calibration, indicate a need for external assistance, or the like), or to convey internal DT states pertinent to the receiving node. In some aspects, the near-RT node may indicate, to the network node, whether a response (e.g., providing the channel characterization data) may be delayed or may include suboptimal information. For example, the network node may utilize such information in the network node’s scheduling strategy (e.g., attaching a lower weight to received channel characterization data, triggering supplementary measurements associated with the received channel characterization data, or the like).

In some aspects, the near-RT node (e.g., including a DT function) may be hosted in a separate node from the first network node (e.g. the node requesting the channel characterization data). For example, the near-RT node may be hosted in a near-RT RIC. Additionally, or alternatively, the near-RT node (e.g., including a DT function) may be hosted in the first network node (e.g., the node requesting the channel characterization data). For example, the near-RT node or the associated DT function may be hosted on an RT RIC, a decentralized application (dApp), or a DT service driver, among other examples. Additionally, the near-RT node or the associated DT function may utilize a shared processor or a dedicated processor associated with the first network node. In some aspects, the first network node’s scheduling service may be the near-RT cache (e.g. associated with the DT function), thereby utilizing DT service-provided information locally to avoid unnecessary or excessive polling of the DT service.

As shown in FIG. 3C, example 322 illustrates an example interaction associated with obtaining channel characterization data. As shown by reference number 324, a non-RT DT node (e.g., including a DT service) may be configured with deployment parameters from a RAN configuration or RU (e.g., a configuration service that provisions information associated with the wireless network). As shown by reference number 326, a UE may transmit, and a network node may receive, a measurement request (e.g., associated with CSI feedback). As shown by reference number 328, the network node may transmit, and a near-RT node may receive, a request for channel characterization data (e.g., based on receiving the measurement request). As shown by reference number 330, the UE may additionally request information (e.g., position, state, or the like) associated with the UE, from an external component (e.g., an LCS, a second party, or a third party).

As shown by reference number 332, the near-RT node may indicate a “miss” based on determining that the near-RT node is missing local twin information for the UE. As shown by reference number 334, the near-RT node may transmit, and the non-RT DT may receive, a request for channel characterization data. As shown by reference number 336, the non-RT DT may request, from the external component, measurement information associated with the UE (e.g., position information, state information, or the like). As shown by reference number 338, the non-RT DT may obtain channel characterization data based on the measurement information. For example, the non-RT DT may utilize location information, status, network node measurements, or the like, to create a DT subspace (e.g., a radius r sphere) around the UE position. As shown by reference number 340, the non-RT DT may transmit, and the near-RT node may receive, channel characterization data associated with the UE (e.g., and based on the DT subspace).

As shown by reference number 342, the near-RT node may supplement the channel characterization data with information from the near-RT node (e.g., the near-RT node may partially fulfill the network node’s request for channel characterization data). As shown by reference number 344, the near-RT node may transmit, and the network node may receive, the channel characterization data, including measurement information associated with a set of measurements associated with the UE.

As shown by reference number 346, the network node may utilize the channel characterization data to determine parameters (e.g., MAC/PHY parameters) based on the channel characterization data (e.g., alone, or in combination with additional measurement information). As shown by reference number 348, the network node may schedule communications (e.g., UE allocation, beams, feedback, or the like), and the UE may transmit feedback (e.g., measurements, automatic repeat request (ARQ), or the like).

Additionally, as shown in FIG. 3D, and by reference number 350, a non-RT DT node (e.g., including a DT service) may be configured with deployment parameters from a RAN configuration or RU (e.g., a configuration service that provisions information associated with the wireless network). As shown by reference number 352, a UE may transmit, and a network node may receive, a measurement request (e.g., associated with CSI feedback). As shown by reference number 354, the network node may transmit, and a near-RT node may receive, a request for channel characterization data (e.g., based on receiving the measurement request). As shown by reference number 356, the UE may additionally request information (e.g., position, state, or the like) associated with the UE, from an external component (e.g., a location control server, a second party, or a third party).

As shown by reference number 358, the near-RT node may indicate a “hit” based on determining that the near-RT node includes local twin information for the UE. Accordingly, the near-RT node may fulfill the request for channel characterization data, independent of the non-RT DT. As shown by reference number 360, the near-RT node may transmit, and the network node may receive, the channel characterization data, including measurement information associated with a set of measurements associated with the UE.

As shown by reference number 362, the network node may utilize the channel characterization data to determine parameters (e.g., MAC/PHY parameters) based on the channel characterization data (e.g., alone, or in combination with additional measurement information). As shown by reference number 364, the network node may schedule communications (e.g., UE allocation, beams, feedback, or the like), and the UE may transmit feedback (e.g., measurements, ARQ, or the like).

Additionally, or alternatively, the near-RT node (e.g., including the DT function) may request information from the DT service. In some aspects, such a request may include an anchor element (e.g., identifying the information needed at the near-RT node), a characterization element that characterizes the anchor element (e.g., to obtain more accurate DT information), a dimension element that characterizes the anchor element (e.g., to determine the amount of DT information), or a representation element (e.g., a type of representation model that may be supported, including a neural network, random forest, tgz-compressed location-tagged metrics, or the like). For example, the anchor element information may include UE location, UE ID, a set of measurements (e.g., a history of channel estimate measurements), an antenna ID, or antenna panel ID, among other examples. Additionally, for example, the characterizing element may include UE orientation, UE title, a CSI-RS configuration, an antenna mask, or an antenna hierarchy limitation, among other examples.

In some aspects, the anchor element, characterizing element, dimension element, or representation element may be included in a set of elements. Additionally, the anchor element, characterizing element, dimension element, or representation element may be implicitly indicated (e.g., only certain elements may be supported) or explicitly indicated. In some aspects, the channel characterization data (e.g., including measurement info) provided, by the DT service, to the near-RT node may arrive on a best effort basis or in a time window, may be partial (e.g., exclude one or more anchors or limit resolution), allow a fallback reply, or include an error (e.g., indicating a GIS overload, a resolution that exceeds a threshold, or the like), among other examples.

As shown in FIGS. 3E-3F, example 366 illustrates that the near-RT node (e.g., including a DT service or function) may be provisioned to optimize transactional performance while preventing an overload of system or network resources.

In some aspects, the near-RT node may be provisioned according to hysteresis conditions (e.g., expressed as a period of time) or measurement tolerance thresholds associated with a UE position. Similarly, the near-RT node may be provisioned with one or more data limitations, including a limitation on the amount of data allowed in a unit of a near-RT and DT service transaction (e.g., quantity of bytes, physical space representation, coherence time, quantization of weights, or the like). For example, the scope of data limitations may be associated with individual transactions, overall quantity of transactions, quantity of transactions over a time period, or the like, and may be averaged, absolute, or approximate.

As shown in FIG. 3E, and by reference number 368, the near-RT node may transmit, and the DT service may receive, a request for channel characterization data. As shown by reference number 370, the DT service may transmit, and the near-RT node may receive, a response including the channel characterization data and an overload prevention indication. For example, the reply from the DT service may indicate one or more parameters instructing the near-DT node to taper future requests. As shown by reference number 372, the overload prevention indication may indicate a time period during which the near-RT node is prohibited from transmitting a subsequent request. As shown by reference number 374, after the expiration of the time period, the near-RT node may transmit a new request for channel characterization data.

As shown by reference number 376, the near-RT node may be configured with one or more overload parameters. As shown by reference number 378, the near-RT node may transmit, and the DT service may receive, a request for channel characterization data. As shown by reference number 380, the DT service may transmit, and the near-RT node may receive, a response including the channel characterization data. As shown by reference number 382, the overload prevention indication may indicate a time period during which the near-RT node is prohibited from transmitting a subsequent request. As shown by reference number 384, after the expiration of the time period, the near-RT node may transmit a new request for channel characterization data.

As shown in FIG. 3F, and by reference numbers 386 and 388, the DT service may transmit, and the near-RT node may receive, a load limit request, indicating a time period during which the near-RT node is prohibited from transmitting a request. As shown by reference number 390, after the expiration of the time period, the near-RT node may transmit a request for channel characterization data.

Additionally, or alternatively, the near-RT node may be provisioned statically, semi-statically, or dynamically in order to control the near-RT node’s cache. For example, semi-static provisioning may be provided via a management plane, a configuration by the DT service, a configuration by a RAN service, or an SMO. Additionally, the semi-static provisioning may be configured in the near-RT node. Furthermore, the dynamic provisioning may be between the DT service and the near-RT node, between the near-RT node and a network node, or between the near-RT node and an SMO, among other examples.

In some aspects, the near-RT node may be configured with a load manager to prohibit or terminate communications between the near-RT node and the DT service. In some aspects, the DT service may enforce the provision parameters (e.g. limiting the resolution of responses to requests, delaying the responses to requests, or the like). Additionally, or alternatively, the near-RT node may be absent as a discrete function and the network node or an additional RAN component may be provisioned with transactional limitations. In some aspects, multiple levels of a near-RT node hierarchy may be present, with the near-RT node being located in relatively closer proximity to the DT service, or the near-RT node being located in relatively closer proximity to the network node or an additional RAN component.

As described herein, in some examples, a DT service may be utilized to obtain channel characterization data associated with a component of a wireless network. For example, a first network node may transmit, to a second network node associated with the DT service, a request for channel characterization data associated with a UE. Additionally, the second network node may transmit, to the first network node, the channel characterization data, including measurement information associated with the UE. The measurement information may be associated with a set of measurements associated with the UE. Additionally, the channel characterization data may include at least one of distribution information or aggregation information, associated with the set of measurements. Furthermore, the measurement information may include a time stamp associated with each measurement of the set of measurements.

In some examples, the described techniques can be used to enable channel sampling without utilizing measurements or OTA overhead resources between one or more network nodes, UEs, or other network components. Additionally, utilizing a DT service may increase observability of components (e.g., endpoints) in the wireless network, for which the network nodes, UEs, or other network components may be unable to sample. For example, the DT service may sample all antenna patches available to the DT service for a hybrid or an analog RFFE architecture. In contrast, the network nodes, UEs, or other network components may be limited to sampling only a subset of antenna patches, due to overhead, energy (e.g., battery), or technological limitations. Furthermore, in some examples, by utilizing the DT service to sample channels, the wireless network may configure network components to maintain RFFE and TRU components in a low energy state, while continuing to sample channels via the DT service. Additionally, by limiting the scope of information available to the near-RT and the periodicity of requests by the near-RT node, the network may provide improved performance of DT-assisted operations while avoiding overloading of the DT service resources.

As indicated above, FIGS. 3A-3F are provided as examples. Other examples may differ from what is described with respect to FIGS. 3A-3F.

FIG. 4 is a diagram illustrating an example process 400 performed, for example, at a first network node or an apparatus of a first network node. Example process 400 is an example where the apparatus or the first network node (e.g., network node 110) performs operations associated with DT-assisted channel characterization.

As shown in FIG. 4, in some aspects, process 400 may include transmitting, to a second network node associated with a DT service, a message including a request for channel characterization data associated with a UE (block 410). For example, the first network node (e.g., using transmission component 704 or communication manager 706, depicted in FIG. 7) may transmit, to a second network node associated with a DT service, a message including a request for channel characterization data associated with a UE, as described above.

As further shown in FIG. 4, in some aspects, process 400 may include receiving, from the second network node, a message including the channel characterization data associated with the UE, wherein the channel characterization data includes measurement information associated with a set of measurements associated with the UE (block 420). For example, the first network node (e.g., using reception component 702 or communication manager 706, depicted in FIG. 7) may receive, from the second network node, a message including the channel characterization data associated with the UE, wherein the channel characterization data includes measurement information associated with a set of measurements associated with the UE, as described above.

Process 400 may include additional aspects, such as any single aspect or any combination of aspects described below or in connection with one or more other processes described elsewhere herein.

In a first aspect, the request includes one or more endpoint indicators associated with the UE.

In a second aspect, alone or in combination with the first aspect, the request includes a measurement scope associated with the set of measurements.

In a third aspect, alone or in combination with one or more of the first and second aspects, the request includes one or more framework configurations for at least one of an endpoint indicator or a measurement scope, associated with the channel characterization data.

In a fourth aspect, alone or in combination with one or more of the first through third aspects, the transmitted message includes a reporting condition configuration indicating one or more reporting conditions for the second network node to transmit, to the first network node, the channel characterization data.

In a fifth aspect, alone or in combination with one or more of the first through fourth aspects, the request includes session information associated with initiation of a session for transmitting a plurality of requests associated with channel characterization data.

In a sixth aspect, alone or in combination with one or more of the first through fifth aspects, the request includes a set of identifiers associated with at least one of an endpoint indicator, a measurement scope, a reporting condition configuration, or a framework configuration, associated with the session.

In a seventh aspect, alone or in combination with one or more of the first through sixth aspects, the measurement information includes distribution information associated with the set of measurements.

In an eighth aspect, alone or in combination with one or more of the first through seventh aspects, the set of measurements are aggregated according to an aggregation configuration.

In a ninth aspect, alone or in combination with one or more of the first through eighth aspects, the measurement information includes a time stamp for each measurement of the set of measurements.

In a tenth aspect, alone or in combination with one or more of the first through ninth aspects, the measurement information includes path information associated with a set of paths and including one or more endpoints associated with the set of paths.

In an eleventh aspect, alone or in combination with one or more of the first through tenth aspects, the path information includes at least one of an amplitude, a gain, an angular spread, a delay spread, a phase distribution, or a Doppler distribution, associated with each path of a subset of the set of paths.

In a twelfth aspect, alone or in combination with one or more of the first through eleventh aspects, the measurement information includes beam information associated with a set of beams.

In a thirteenth aspect, alone or in combination with one or more of the first through twelfth aspects, the beam information includes information associated with a beam object pairing.

In a fourteenth aspect, alone or in combination with one or more of the first through thirteenth aspects, the beam information identifies a beam, of the set of beams, according to at least one of a codeword, a set of port weights, a physical characterization, a radiation pattern, a codebook, or a set of beam conditions.

In a fifteenth aspect, alone or in combination with one or more of the first through fourteenth aspects, the beam information includes at least one of an amplitude, a gain, an angular spread, a delay spread, a phase distribution, or a Doppler distribution, associated with each beam of the set of beams.

In a sixteenth aspect, alone or in combination with one or more of the first through fifteenth aspects, the request includes a profile configuration indicating one or more data types to be included in the channel characterization data.

In a seventeenth aspect, alone or in combination with one or more of the first through sixteenth aspects, the request is associated with a profile configuration indicating one or more data types to be included in the channel characterization data.

In an eighteenth aspect, alone or in combination with one or more of the first through seventeenth aspects, the channel characterization data is received, at the first network node, according to a configuration obtained from an external entity.

In a nineteenth aspect, alone or in combination with one or more of the first through eighteenth aspects, the received message indicates one or more missing components of the measurement information, associated with the requested channel characterization data, that are missing from the received channel characterization data.

In a twentieth aspect, alone or in combination with one or more of the first through nineteenth aspects, the received message includes a request for the first network node to transmit, to the second network node, an updated request for channel characterization data, including information associated with the one or more missing components.

In a twenty-first aspect, alone or in combination with one or more of the first through twentieth aspects, the received message indicates one or more conditions associated with the one or more missing components.

In a twenty-second aspect, alone or in combination with one or more of the first through twenty-first aspects, the received channel characterization data may include accuracy information that indicates one or more accuracy properties associated with one or more measurements of the set of measurements.

In a twenty-third aspect, alone or in combination with one or more of the first through twenty-second aspects, the UE is a virtual representation of a UE.

In a twenty-fourth aspect, alone or in combination with one or more of the first through twenty-third aspects, the first network node is associated with a DT-SON service associated with one or more virtual nodes having a set of complementary metrics associated with the channel characterization data.

In a twenty-fifth aspect, alone or in combination with one or more of the first through twenty-fourth aspects, the DT-SON service is configured with a set of characteristics, a set of conditions, and a set of targets associated with a set of parameter goals.

In a twenty-sixth aspect, alone or in combination with one or more of the first through twenty-fifth aspects, one or more parameter goals, of the set of parameter goals, are satisfied based on a determination that one or more complementary metrics, of the set of complementary metrics, satisfy one or more conditions associated with one or more targets, of the set of targets.

In a twenty-seventh aspect, alone or in combination with one or more of the first through twenty-sixth aspects, the DT-SON service includes a plurality of DT-SON instances, and each DT-SON instance differs according to at least one of a DT fabric, an optimization parameter set, or a control parameter set, associated with each respective DT-SON instance.

In a twenty-eighth aspect, alone or in combination with one or more of the first through twenty-seventh aspects, the DT-SON service generates calibration information associated with the one or more virtual nodes, based on a comparison between the complementary metrics and one or more physical metrics associated with a wireless environment.

In a twenty-ninth aspect, alone or in combination with one or more of the first through twenty-eighth aspects, the DT-SON service determines an optimized set of uplink beams or downlink beams for communication in a wireless network associated with the first network node, based on one or more complementary metrics of the set of complementary metrics.

In a thirtieth aspect, alone or in combination with one or more of the first through twenty-ninth aspects, process 400 includes receiving, from the second network node, a message including a request for one or more measurements, of the set of measurements, associated with the UE, and transmitting, to the second network node, a message including the one or more requested measurements associated with the UE.

In a thirty-first aspect, alone or in combination with one or more of the first through thirtieth aspects, the DT service includes a near-RT DT service.

In a thirty-second aspect, alone or in combination with one or more of the first through thirty-first aspects, the near-RT DT service may fulfill all or part of the request for channel characterization data.

In a thirty-third aspect, alone or in combination with one or more of the first through thirty-second aspects, the near-RT DT service may obtain channel characterization data from one or more components of the second network node.

In a thirty-fourth aspect, alone or in combination with one or more of the first through thirty-third aspects, the near-RT DT service may obtain the channel characterization data via a request for an anchor element, a characterizing element, a dimension element, and a representation element.

In a thirty-fifth aspect, alone or in combination with one or more of the first through thirty-fourth aspects, the near-RT DT service is hosted on a separate node from the first network node.

In a thirty-sixth aspect, alone or in combination with one or more of the first through thirty-fifth aspects, the near-RT DT service is hosted on the first network node.

In a thirty-seventh aspect, alone or in combination with one or more of the first through thirty-sixth aspects, the near-RT DT service is configured with a provisioning configuration indicating one or more measurement parameters associated with the channel characterization data.

In a thirty-eighth aspect, alone or in combination with one or more of the first through thirty-seventh aspects, the near-RT DT service is configured with a communication configuration indicating one or more parameters for communicating with the first network node and with one or more components of the second network node.

In a thirty-ninth aspect, alone or in combination with one or more of the first through thirty-eighth aspects, the first network node obtains measurement information from the UE.

In a fortieth aspect, alone or in combination with one or more of the first through thirty-ninth aspects, the measurement information includes one or more complementary metrics associated with the UE.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a second network node or an apparatus of a second network node. Example process 500 is an example where the apparatus or the second network node (e.g., a disaggregated control unit 170) performs operations associated with DT-assisted channel characterization.

As shown in FIG. 5, in some aspects, process 500 may include receiving, from a first network node, a message including a request for channel characterization data associated with a UE (block 510). For example, the second network node (e.g., using reception component 702 or communication manager 706, depicted in FIG. 7) may receive, from a first network node, a message including a request for channel characterization data associated with a UE, as described above.

As further shown in FIG. 5, in some aspects, process 500 may include transmitting, to the first network node, a message including the channel characterization data associated with the UE, wherein the channel characterization data includes measurement information associated with a set of measurements associated with the UE (block 520). For example, the second network node (e.g., using transmission component 704 or communication manager 706, depicted in FIG. 7) may transmit, to the first network node, a message including the channel characterization data associated with the UE, wherein the channel characterization data includes measurement information associated with a set of measurements associated with the UE, as described above.

Process 500 may include additional aspects, such as any single aspect or any combination of aspects described below or in connection with one or more other processes described elsewhere herein.

In a first aspect, the request includes one or more endpoint indicators associated with the UE.

In a second aspect, alone or in combination with the first aspect, the request includes a measurement scope associated with the set of measurements.

In a third aspect, alone or in combination with one or more of the first and second aspects, the request includes one or more framework configurations for at least one of an endpoint indicator or a measurement scope, associated with the channel characterization data.

In a fourth aspect, alone or in combination with one or more of the first through third aspects, the request includes a reporting condition configuration indicating one or more reporting conditions for transmitting, to the first network node, the channel characterization data.

In a fifth aspect, alone or in combination with one or more of the first through fourth aspects, the request includes session information associated with initiation of a session for receiving a plurality of requests associated with channel characterization data.

In a sixth aspect, alone or in combination with one or more of the first through fifth aspects, the request includes a set of identifiers associated with at least one of an endpoint indicator, a measurement scope, a reporting condition configuration, or a framework configuration, associated with the session.

In a seventh aspect, alone or in combination with one or more of the first through sixth aspects, the measurement information includes distribution information associated with the set of measurements.

In an eighth aspect, alone or in combination with one or more of the first through seventh aspects, the set of measurements are aggregated according to an aggregation configuration.

In a ninth aspect, alone or in combination with one or more of the first through eighth aspects, the measurement information includes a time stamp for each measurement of the set of measurements.

In a tenth aspect, alone or in combination with one or more of the first through ninth aspects, the measurement information includes path information associated with a set of paths and including one or more endpoints associated with the set of paths.

In an eleventh aspect, alone or in combination with one or more of the first through tenth aspects, the path information includes at least one of an amplitude, a gain, an angular spread, a delay spread, a phase distribution, or a Doppler distribution, associated with each path of a subset of the set of paths.

In a twelfth aspect, alone or in combination with one or more of the first through eleventh aspects, the measurement information includes beam information associated with a set of beams.

In a thirteenth aspect, alone or in combination with one or more of the first through twelfth aspects, the beam information includes information associated with a beam object pairing.

In a fourteenth aspect, alone or in combination with one or more of the first through thirteenth aspects, the beam information identifies a beam, of the set of beams, according to at least one of a codeword, a set of port weights, a physical characterization, a radiation pattern, a codebook, or a set of beam conditions.

In a fifteenth aspect, alone or in combination with one or more of the first through fourteenth aspects, the beam information includes at least one of an amplitude, a gain, an angular spread, a delay spread, a phase distribution, or a Doppler distribution, associated with each beam of the set of beams.

In a sixteenth aspect, alone or in combination with one or more of the first through fifteenth aspects, the request includes a profile configuration indicating one or more data types to be included in the channel characterization data.

In a seventeenth aspect, alone or in combination with one or more of the first through sixteenth aspects, the request includes a request to obtain a profile configuration indicating one or more data types to be included in the channel characterization data.

In an eighteenth aspect, alone or in combination with one or more of the first through seventeenth aspects, the channel characterization data is transmitted to the first network node according to a configuration obtained, by the second network node, from an external entity.

The method of claim 42, the channel characterization data is transmitted to the first network node according to a transmission configuration, independent of receiving the request from the first network node.

In a nineteenth aspect, alone or in combination with one or more of the first through eighteenth aspects, the transmitted message indicates one or more missing components of the measurement information, associated with the requested channel characterization data, that are missing from the received channel characterization data.

In a twentieth aspect, alone or in combination with one or more of the first through nineteenth aspects, the transmitted message includes a request for the first network node to transmit, to the second network node, an updated request for channel characterization data, including information associated with the one or more missing components.

In a twenty-first aspect, alone or in combination with one or more of the first through twentieth aspects, the transmitted message indicates one or more conditions associated with the one or more missing components.

In a twenty-second aspect, alone or in combination with one or more of the first through twenty-first aspects, the transmitted channel characterization data may include accuracy information that indicates one or more accuracy properties associated with one or more measurements of the set of measurements.

In a twenty-third aspect, alone or in combination with one or more of the first through twenty-second aspects, the UE is a virtual representation of a UE.

In a twenty-fourth aspect, alone or in combination with one or more of the first through twenty-third aspects, process 500 includes obtaining the measurement information associated with the channel characterization data.

In a twenty-fifth aspect, alone or in combination with one or more of the first through twenty-fourth aspects, the measurement information is translated from a first data type to a second data type, prior to transmitting the channel characterization data to the first network node.

In a twenty-sixth aspect, alone or in combination with one or more of the first through twenty-fifth aspects, the measurement information is obtained from one or more external components.

In a twenty-seventh aspect, alone or in combination with one or more of the first through twenty-sixth aspects, the measurement information is obtained from one or more external components, based on the requested channel characterization data including measurement information associated with the one or more external components.

In a twenty-eighth aspect, alone or in combination with one or more of the first through twenty-seventh aspects, the second network node is associated with a DT-SON service associated with one or more virtual nodes having a set of complementary metrics associated with the channel characterization data.

In a twenty-ninth aspect, alone or in combination with one or more of the first through twenty-eighth aspects, the DT-SON service is configured with a set of characteristics, a set of conditions, and a set of targets associated with a set of parameter goals.

In a thirtieth aspect, alone or in combination with one or more of the first through twenty-ninth aspects, one or more parameter goals, of the set of parameter goals, are satisfied based on a determination that one or more complementary metrics, of the set of complementary metrics, satisfy one or more conditions associated with one or more targets, of the set of targets.

In a thirty-first aspect, alone or in combination with one or more of the first through thirtieth aspects, the DT-SON service includes a plurality of DT-SON instances, and each DT-SON instance differs according to at least one of a DT fabric, an optimization parameter set, or a control parameter set, associated with each respective DT-SON instance.

In a thirty-second aspect, alone or in combination with one or more of the first through thirty-first aspects, the DT-SON service generates calibration information associated with the one or more virtual nodes, based on a comparison between the complementary metrics and one or more physical metrics associated with a wireless environment.

In a thirty-third aspect, alone or in combination with one or more of the first through thirty-second aspects, the DT-SON service determines an optimized set of uplink beams or downlink beams for communication in a wireless network associated with the first network node, based on one or more complementary metrics of the set of complementary metrics.

In a thirty-fourth aspect, alone or in combination with one or more of the first through thirty-third aspects, process 500 includes transmitting, to the first network node, a message including a request for one or more measurements, of the set of measurements, associated with the UE, and receiving, from the first network node, a message including the one or more requested measurements associated with the UE.

In a thirty-fifth aspect, alone or in combination with one or more of the first through thirty-fourth aspects, the channel characterization data includes measurement information that is unsupported by one or more active over-the-air protocols.

In a thirty-sixth aspect, alone or in combination with one or more of the first through thirty-fifth aspects, the measurement information that is unsupported by one or more OTA protocols is obtained from one or more of the first network node, the UE, or an external component.

In a thirty-seventh aspect, alone or in combination with one or more of the first through thirty-sixth aspects, the DT service includes a near-RT DT service.

In a thirty-eighth aspect, alone or in combination with one or more of the first through thirty-seventh aspects, the near-RT DT service may fulfill all or part of the request for channel characterization data.

In a thirty-ninth aspect, alone or in combination with one or more of the first through thirty-eighth aspects, the near-RT DT service may obtain channel characterization data from one or more components of the second network node.

In a fortieth aspect, alone or in combination with one or more of the first through thirty-ninth aspects, the near-RT DT service may obtain the channel characterization data via a request for an anchor element, a characterizing element, a dimension element, and a representation element.

In a forty-first aspect, alone or in combination with one or more of the first through fortieth aspects, the near-RT DT service is hosted on a separate node from the first network node.

In a forty-second aspect, alone or in combination with one or more of the first through forty-first aspects, the near-RT DT service is hosted on the first network node.

In a forty-third aspect, alone or in combination with one or more of the first through forty-second aspects, the near-RT DT service is configured with a provisioning configuration indicating one or more measurement parameters associated with the channel characterization data.

In a forty-fourth aspect, alone or in combination with one or more of the first through forty-third aspects, the near-RT DT service is configured with a communication configuration indicating one or more parameters for communicating with the first network node and with one or more components of the second network node.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a first network node, or a first network node may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 155 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 145 described in connection with FIG. 1) of the first network node.

In some aspects, the apparatus 600 may be configured to perform one or more operations described herein in connection with FIGS. 3A-3F. Additionally, or alternatively, the apparatus 600 may be configured to perform one or more processes described herein, such as process 400 of FIG. 4. In some aspects, the apparatus 600 or one or more components shown in FIG. 6 may include one or more components of the first network node described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the first network node described above in connection with FIG. 1, such as a radio, one or more RF chains, one or more transceivers, or one or more modems, each of which may in turn be coupled with one or more antennas of the first network node. In some aspects, the reception component 602 or the transmission component 604 may include or may be included in a network interface. The network interface may be configured to obtain or output signals for the apparatus 600 via one or more communications links, such as a backhaul link, a midhaul link, or a fronthaul link.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the first network node described above in connection with FIG. 1, such as a radio, one or more RF chains, one or more transceivers, or one or more modems, each of which may in turn be coupled with one or more antennas of the first network node described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The transmission component 604 may transmit, to a second network node associated with a DT service, a message including a request for channel characterization data associated with a UE. The reception component 602 may receive, from the second network node, a message including the channel characterization data associated with the UE, wherein the channel characterization data includes measurement information associated with a set of measurements associated with the UE.

The reception component 602 may receive, from the second network node, a message including a request for one or more measurements, of the set of measurements, associated with the UE.

The transmission component 604 may transmit, to the second network node, a message including the one or more requested measurements associated with the UE.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a second network node, or a second network node may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the second network node.

In some aspects, the apparatus 700 may be configured to perform one or more operations described herein in connection with FIGS. 3A-3F. Additionally, or alternatively, the apparatus 700 may be configured to perform one or more processes described herein, such as process 500 of FIG. 5. In some aspects, the apparatus 700 or one or more components shown in FIG. 7 may include one or more components of the second network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the second network node described above in connection with FIG. 1, such as a radio, one or more RF chains, one or more transceivers, or one or more modems, each of which may in turn be coupled with one or more antennas of the second network node. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the second network node described above in connection with FIG. 1, such as a radio, one or more RF chains, one or more transceivers, or one or more modems, each of which may in turn be coupled with one or more antennas of the second network node described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, from a first network node, a message including a request for channel characterization data associated with a UE. The transmission component 704 may transmit, to the first network node, a message including the channel characterization data associated with the UE, wherein the channel characterization data includes measurement information associated with a set of measurements associated with the UE.

The reception component 702 may obtain the measurement information associated with the channel characterization data.

The transmission component 704 may transmit, to the first network node, a message including a request for one or more measurements, of the set of measurements, associated with the UE.

The reception component 702 may receive, from the first network node, a message including the one or more requested measurements associated with the UE.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

### The following provides an overview of some Aspects of the present disclosure

Aspect 1: A method of wireless communication performed by a first network node, comprising: transmitting, to a second network node associated with a digital-twin (DT) service, a message including a request for channel characterization data associated with a user equipment (UE); and receiving, from the second network node, a message including the channel characterization data associated with the UE, wherein the channel characterization data includes measurement information associated with a set of measurements associated with the UE.

Aspect 2: The method of Aspect 1, wherein the request includes one or more endpoint indicators associated with the UE.

Aspect 3: The method of any of Aspects 1-2, wherein the request includes a measurement scope associated with the set of measurements.

Aspect 4: The method of any of Aspects 1-3, wherein the request includes one or more framework configurations for at least one of an endpoint indicator or a measurement scope, associated with the channel characterization data.

Aspect 5: The method of any of Aspects 1-4, wherein the transmitted message includes a reporting condition configuration indicating one or more reporting conditions for the second network node to transmit, to the first network node, the channel characterization data.

Aspect 6: The method of any of Aspects 1-5, wherein the request includes session information associated with initiation of a session for transmitting a plurality of requests associated with channel characterization data.

Aspect 7: The method of Aspect 6, wherein the request includes a set of identifiers associated with at least one of an endpoint indicator, a measurement scope, a reporting condition configuration, or a framework configuration, associated with the session.

Aspect 8: The method of any of Aspects 1-7, wherein the measurement information includes distribution information associated with the set of measurements.

Aspect 9: The method of any of Aspects 1-8, wherein the set of measurements are aggregated according to an aggregation configuration.

Aspect 10: The method of any of Aspects 1-9, wherein the measurement information includes a time stamp for each measurement of the set of measurements.

Aspect 11: The method of any of Aspects 1-10, wherein the measurement information includes path information associated with a set of paths and including one or more endpoints associated with the set of paths.

Aspect 12: The method of Aspect 11, wherein the path information includes at least one of an amplitude, a gain, an angular spread, a delay spread, a phase distribution, or a Doppler distribution, associated with each path of a subset of the set of paths.

Aspect 13: The method of any of Aspects 1-12, wherein the measurement information includes beam information associated with a set of beams.

Aspect 14: The method of Aspect 13, wherein the beam information includes information associated with a beam object pairing.

Aspect 15: The method of Aspect 13, wherein the beam information identifies a beam, of the set of beams, according to at least one of a codeword, a set of port weights, a physical characterization, a radiation pattern, a codebook, or a set of beam conditions.

Aspect 16: The method of Aspect 13, wherein the beam information includes at least one of an amplitude, a gain, an angular spread, a delay spread, a phase distribution, or a Doppler distribution, associated with each beam of the set of beams.

Aspect 17: The method of any of Aspects 1-16, wherein the request includes a profile configuration indicating one or more data types to be included in the channel characterization data.

Aspect 18: The method of any of Aspects 1-17, wherein the request is associated with a profile configuration indicating one or more data types to be included in the channel characterization data.

Aspect 19: The method of any of Aspects 1-18, wherein the channel characterization data is received, at the first network node, according to a configuration obtained from an external entity.

Aspect 20: The method of any of Aspects 1-19, wherein the received message indicates one or more missing components of the measurement information, associated with the requested channel characterization data, that are missing from the received channel characterization data.

Aspect 21: The method of Aspect 20, wherein the received message includes a request for the first network node to transmit, to the second network node, an updated request for channel characterization data, including information associated with the one or more missing components.

Aspect 22: The method of Aspect 20, wherein the received message indicates one or more conditions associated with the one or more missing components.

Aspect 23: The method of any of Aspects 1-22, wherein the received channel characterization data may include accuracy information that indicates one or more accuracy properties associated with one or more measurements of the set of measurements.

Aspect 24: The method of any of Aspects 1-23, wherein the UE is a virtual representation of a UE.

Aspect 25: The method of any of Aspects 1-24, wherein the first network node is associated with a DT self-organizing network (DT-SON) service associated with one or more virtual nodes having a set of complementary metrics associated with the channel characterization data.

Aspect 26: The method of Aspect 25, wherein the DT-SON service is configured with a set of characteristics, a set of conditions, and a set of targets associated with a set of parameter goals.

Aspect 27: The method of Aspect 26, wherein one or more parameter goals, of the set of parameter goals, are satisfied based on a determination that one or more complementary metrics, of the set of complementary metrics, satisfy one or more conditions associated with one or more targets, of the set of targets.

Aspect 28: The method of Aspect 25, wherein the DT-SON service includes a plurality of DT-SON instances, and wherein each DT-SON instance differs according to at least one of a DT fabric, an optimization parameter set, or a control parameter set, associated with each respective DT-SON instance.

Aspect 29: The method of Aspect 25, wherein the DT-SON service generates calibration information associated with the one or more virtual nodes, based on a comparison between the complementary metrics and one or more physical metrics associated with a wireless environment.

Aspect 30: The method of Aspect 25, wherein the DT-SON service determines an optimized set of uplink beams or downlink beams for communication in a wireless network associated with the first network node, based on one or more complementary metrics of the set of complementary metrics.

Aspect 31: The method of any of Aspects 1-30, further comprising: receiving, from the second network node, a message including a request for one or more measurements, of the set of measurements, associated with the UE; and transmitting, to the second network node, a message including the one or more requested measurements associated with the UE.

Aspect 32: The method of any of Aspects 1-31, wherein the DT service includes a near-real-time (near-RT) DT service.

Aspect 33: The method of Aspect 32, wherein the near-RT DT service may fulfill all or part of the request for channel characterization data.

Aspect 34: The method of Aspect 33, wherein the near-RT DT service may obtain channel characterization data from one or more components of the second network node.

Aspect 35: The method of Aspect 34, wherein the near-RT DT service may obtain the channel characterization data via a request for an anchor element, a characterizing element, a dimension element, and a representation element.

Aspect 36: The method of Aspect 32, wherein the near-RT DT service is hosted on a separate node from the first network node.

Aspect 37: The method of Aspect 32, wherein the near-RT DT service is hosted on the first network node.

Aspect 38: The method of Aspect 32, wherein the near-RT DT service is configured with a provisioning configuration indicating one or more measurement parameters associated with the channel characterization data.

Aspect 39: The method of Aspect 31, wherein the near-RT DT service is configured with a communication configuration indicating one or more parameters for communicating with the first network node and with one or more components of the second network node.

Aspect 40: The method of any of Aspects 1-39, wherein the first network node obtains measurement information from the UE.

Aspect 41: The method of Aspect 40, wherein the measurement information includes one or more complementary metrics associated with the UE.

Aspect 42: A method of wireless communication performed by a second network node associated with a digital-twin (DT) service, comprising: receiving, from a first network node, a message including a request for channel characterization data associated with a user equipment (UE); and transmitting, to the first network node, a message including the channel characterization data associated with the UE, wherein the channel characterization data includes measurement information associated with a set of measurements associated with the UE.

Aspect 43: The method of Aspect 42, wherein the request includes one or more endpoint indicators associated with the UE.

Aspect 44: The method of any of Aspects 42-43, wherein the request includes a measurement scope associated with the set of measurements.

Aspect 45: The method of any of Aspects 42-44, wherein the request includes one or more framework configurations for at least one of an endpoint indicator or a measurement scope, associated with the channel characterization data.

Aspect 46: The method of any of Aspects 42-45, wherein the request includes a reporting condition configuration indicating one or more reporting conditions for transmitting, to the first network node, the channel characterization data.

Aspect 47: The method of any of Aspects 42-46, wherein the request includes session information associated with initiation of a session for receiving a plurality of requests associated with channel characterization data.

Aspect 48: The method of Aspect 47, wherein the request includes a set of identifiers associated with at least one of an endpoint indicator, a measurement scope, a reporting condition configuration, or a framework configuration, associated with the session.

Aspect 49: The method of any of Aspects 42-48, wherein the measurement information includes distribution information associated with the set of measurements.

Aspect 50: The method of any of Aspects 42-49, wherein the set of measurements are aggregated according to an aggregation configuration.

Aspect 51: The method of any of Aspects 42-50, wherein the measurement information includes a time stamp for each measurement of the set of measurements.

Aspect 52: The method of any of Aspects 42-51, wherein the measurement information includes path information associated with a set of paths and including one or more endpoints associated with the set of paths.

Aspect 53: The method of Aspect 52, wherein the path information includes at least one of an amplitude, a gain, an angular spread, a delay spread, a phase distribution, or a Doppler distribution, associated with each path of a subset of the set of paths.

Aspect 54: The method of any of Aspects 42-53, wherein the measurement information includes beam information associated with a set of beams.

Aspect 55: The method of Aspect 54, wherein the beam information includes information associated with a beam object pairing.

Aspect 56: The method of Aspect 54, wherein the beam information identifies a beam, of the set of beams, according to at least one of a codeword, a set of port weights, a physical characterization, a radiation pattern, a codebook, or a set of beam conditions.

Aspect 57: The method of Aspect 54, wherein the beam information includes at least one of an amplitude, a gain, an angular spread, a delay spread, a phase distribution, or a Doppler distribution, associated with each beam of the set of beams.

Aspect 58: The method of any of Aspects 42-57, wherein the request includes a profile configuration indicating one or more data types to be included in the channel characterization data.

Aspect 59: The method of any of Aspects 42-58, wherein the request includes a request to obtain a profile configuration indicating one or more data types to be included in the channel characterization data.

Aspect 60: The method of any of Aspects 42-59, wherein the channel characterization data is transmitted to the first network node according to a configuration obtained, by the second network node, from an external entity.

Aspect 61: The method of any of Aspects 42-60, wherein the channel characterization data is transmitted to the first network node according to a transmission configuration, independent of receiving the request from the first network node.

Aspect 62: The method of any of Aspects 42-61, wherein the transmitted message indicates one or more missing components of the measurement information, associated with the requested channel characterization data, that are missing from the received channel characterization data.

Aspect 63: The method of Aspect 62, wherein the transmitted message includes a request for the first network node to transmit, to the second network node, an updated request for channel characterization data, including information associated with the one or more missing components.

Aspect 64: The method of Aspect 62, wherein the transmitted message indicates one or more conditions associated with the one or more missing components.

Aspect 65: The method of any of Aspects 42-64, wherein the transmitted channel characterization data may include accuracy information that indicates one or more accuracy properties associated with one or more measurements of the set of measurements.

Aspect 66: The method of any of Aspects 42-65, wherein the UE is a virtual representation of a UE.

Aspect 67: The method of any of Aspects 42-66, further comprising: obtaining the measurement information associated with the channel characterization data.

Aspect 68: The method of Aspect 67, wherein the measurement information is translated from a first data type to a second data type, prior to transmitting the channel characterization data to the first network node.

Aspect 69: The method of Aspect 67, wherein the measurement information is obtained from one or more external components.

Aspect 70: The method of Aspect 69, wherein the measurement information is obtained from one or more external components, based on the requested channel characterization data including measurement information associated with the one or more external components.

Aspect 71: The method of any of Aspects 42-70, wherein the second network node is associated with a DT self-organizing network (DT-SON) service associated with one or more virtual nodes having a set of complementary metrics associated with the channel characterization data.

Aspect 72: The method of Aspect 71, wherein the DT-SON service is configured with a set of characteristics, a set of conditions, and a set of targets associated with a set of parameter goals.

Aspect 73: The method of Aspect 72, wherein one or more parameter goals, of the set of parameter goals, are satisfied based on a determination that one or more complementary metrics, of the set of complementary metrics, satisfy one or more conditions associated with one or more targets, of the set of targets.

Aspect 74: The method of Aspect 71, wherein the DT-SON service includes a plurality of DT-SON instances, and wherein each DT-SON instance differs according to at least one of a DT fabric, an optimization parameter set, or a control parameter set, associated with each respective DT-SON instance.

Aspect 75: The method of Aspect 71, wherein the DT-SON service generates calibration information associated with the one or more virtual nodes, based on a comparison between the complementary metrics and one or more physical metrics associated with a wireless environment.

Aspect 76: The method of Aspect 71, wherein the DT-SON service determines an optimized set of uplink beams or downlink beams for communication in a wireless network associated with the first network node, based on one or more complementary metrics of the set of complementary metrics.

Aspect 77: The method of any of Aspects 42-76, further comprising: transmitting, to the first network node, a message including a request for one or more measurements, of the set of measurements, associated with the UE; and receiving, from the first network node, a message including the one or more requested measurements associated with the UE.

Aspect 78: The method of any of Aspects 42-77, wherein the channel characterization data includes measurement information that is unsupported by one or more active over-the-air protocols.

Aspect 79: The method of Aspect 78, wherein the measurement information that is unsupported by one or more OTA protocols is obtained from one or more of the first network node, the UE, or an external component.

Aspect 80: The method of any of Aspects 42-79, wherein the DT service includes a near-real-time (near-RT) DT service.

Aspect 81: The method of Aspect 80, wherein the near-RT DT service may fulfill all or part of the request for channel characterization data.

Aspect 82: The method of Aspect 81, wherein the near-RT DT service may obtain channel characterization data from one or more components of the second network node.

Aspect 83: The method of Aspect 82, wherein the near-RT DT service may obtain the channel characterization data via a request for an anchor element, a characterizing element, a dimension element, and a representation element.

Aspect 84: The method of Aspect 80, wherein the near-RT DT service is hosted on a separate node from the first network node.

Aspect 85: The method of Aspect 80, wherein the near-RT DT service is hosted on the first network node.

Aspect 86: The method of Aspect 80, wherein the near-RT DT service is configured with a provisioning configuration indicating one or more measurement parameters associated with the channel characterization data.

Aspect 87: The method of Aspect 80, wherein the near-RT DT service is configured with a communication configuration indicating one or more parameters for communicating with the first network node and with one or more components of the second network node.

Aspect 88: A system configured to perform one or more operations recited in one or more of Aspects 1-87.

Aspect 89: An apparatus comprising means for performing one or more operations recited in one or more of Aspects 1-87.

Aspect 90: A non-transitory computer-readable medium storing a set of instructions, the set of instructions comprising one or more instructions that, when executed by a device, cause the device to perform one or more operations recited in one or more of Aspects 1-87.

Aspect 91: A computer program product comprising instructions or code for executing one or more operations recited in one or more of Aspects 1-87.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first network node, comprising:
a processing system that includes one or more processors and one or more code-storing memories coupled with the one or more processors, the processing system configured to cause the first network node to:
transmit, to a second network node associated with a digital-twin (DT) service, a message including a request for channel characterization data associated with a user equipment (UE); and
receive, from the second network node, a message including the channel characterization data associated with the UE, wherein the channel characterization data includes measurement information associated with a set of measurements associated with the UE.

2. The first network node of claim 1, wherein the request includes one or more endpoint indicators associated with the UE.

3. The first network node of claim 1, wherein the request includes a measurement scope associated with the set of measurements.

4. The first network node of claim 1, wherein the request includes one or more framework configurations for at least one of an endpoint indicator or a measurement scope, associated with the channel characterization data.

5. The first network node of claim 1, wherein the transmitted message includes a reporting condition configuration indicating one or more reporting conditions for the second network node to transmit, to the first network node, the channel characterization data.

6. The first network node of claim 1, wherein the measurement information includes distribution information associated with the set of measurements.

7. The first network node of claim 1, wherein the set of measurements are aggregated according to an aggregation configuration.

8. The first network node of claim 1, wherein the measurement information includes path information associated with a set of paths and including one or more endpoints associated with the set of paths.

9. The first network node of claim 8, wherein the path information includes at least one of an amplitude, a gain, an angular spread, a delay spread, a phase distribution, or a Doppler distribution, associated with each path of a subset of the set of paths.

10. The first network node of claim 1, wherein the measurement information includes beam information associated with a set of beams.

11. The first network node of claim 10, wherein the beam information identifies a beam, of the set of beams, according to at least one of a codeword, a set of port weights, a physical characterization, a radiation pattern, a codebook, or a set of beam conditions.

12. The first network node of claim 10, wherein the beam information includes at least one of an amplitude, a gain, an angular spread, a delay spread, a phase distribution, or a Doppler distribution, associated with each beam of the set of beams.

13. The first network node of claim 1, wherein the request includes a profile configuration indicating one or more data types to be included in the channel characterization data.

14. The first network node of claim 1, wherein the received message indicates one or more missing components of the measurement information, associated with the requested channel characterization data, that are missing from the received channel characterization data.

15. The first network node of claim 1, wherein the received channel characterization data includes accuracy information that indicates one or more accuracy properties associated with one or more measurements of the set of measurements.

16. The first network node of claim 1, wherein the first network node is associated with a DT self-organizing network (DT-SON) service associated with one or more virtual nodes having a set of complementary metrics associated with the channel characterization data.

17. A second network node, comprising:
a processing system that includes one or more processors and one or more code-storing memories coupled with the one or more processors, the processing system configured to cause the second network node to:
receive, from a first network node, a message including a request for channel characterization data associated with a user equipment (UE); and
transmit, to the first network node, a message including the channel characterization data associated with the UE, wherein the channel characterization data includes measurement information associated with a set of measurements associated with the UE, and
wherein the channel characterization data includes beam information associated with a set of beams.

18. The second network node of claim 17, wherein the channel characterization data is transmitted to the first network node according to a configuration obtained, by the second network node, from an external entity.

19. The second network node of claim 17, wherein the processing system is configured to cause the second network node to:
obtain the measurement information associated with the channel characterization data, wherein the measurement information is obtained from one or more external components.

20. A method of wireless communication performed by a first network node, comprising:
transmitting, to a second network node associated with a digital-twin (DT) service, a message including a request for channel characterization data associated with a user equipment (UE); and
receiving, from the second network node, a message including the channel characterization data associated with the UE, wherein the channel characterization data includes measurement information associated with a set of measurements associated with the UE.
